(19) United States
(12) Patent Application Publication
(10) Pub. No.: US 2007/0147332 A1
(43) Pub. Date: Jun. 28, 2007

(54) Multimode support for wireless communications

(76) Inventors: Antti Lappetelainen, Espoo (FI); Hannu E. Laine, Espoo (FI); Arto Palin, Viiala (FI); Jukka Reunamaki, Tampere (FI)

Correspondence Address: MORGAN & FINNEGAN, LLP, 3 World Financial Center, New York, NY, 10281-2101, US

(21) Appl. No.: 11/319,163

(22) Filed: Dec. 28, 2005

(51) Int. Cl. H04J 3/16; H04L 12/403

(52) U.S. Cl. 370/346; 370/449

(57) ABSTRACT

A plurality of polling response transmission times are allocated for a corresponding plurality of remote devices. The remote devices operate according to a first wireless transmission mode, such as Bluetooth LEE. These allocated polling response transmission times are outside of a time interval designated for communications according to a second wireless transmission mode, such as Bluetooth. Each of the polling response transmission times may be offset from a polling packet transmission time by a corresponding delay interval. In addition, a polling packet to the plurality of remote devices is transmitted, and one or more responses to the polling packet are received. Each of these responses is sent by one of the remote devices during its corresponding polling response transmission time. In addition, communications according to the second wireless transmission mode may be conducted during the designated time interval.

### FIELD OF THE INVENTION

The present invention relates to communications. More particularly, the present invention relates to techniques that provide for the efficient transfer of information among multiple devices.

### BACKGROUND OF THE INVENTION

Short range wireless systems typically involve devices that have a communications range of one hundred meters or less. To provide communications over long distances, these short range systems often interface with other networks. For example, short range networks may interface with cellular networks, wireline telecommunications networks, and the Internet.

Bluetooth defines a short-range radio network, originally intended as a cable replacement. It can be used to create ad hoc networks (also referred to as piconets) of multiple devices, where one device is referred to as a master device. The other devices are referred to as slave devices. The slave devices can communicate with the master device and with each other via the master device. The devices operate in the 2.4 GHz radio band reserved for general use by Industrial, Scientific, and Medical (ISM) applications. Bluetooth devices are designed to find other Bluetooth devices within their communications range and to discover what services they offer.

Bluetooth implements a frequency hopping system derived from the master's Bluetooth clock signal and device address. Generally, the hop rate in a normal connection is 1600 hops/s. Transmissions are conducted during specified time slots that are determined according to a predetermined hopping scheme, (e.g., the duration of a time slot is 625 μs). According to the Bluetooth protocol, a master device may start transmitting only in even-numbered slots, whereas the slave devices may transmit in odd-numbered slots. The data packets may occupy 1, 3 or 5 slots. The whole packet is always transmitted in the same channel. The master polls one slave at the time. Each slave transmits a response message back to the master after receiving the poll. The active slave devices recognize their packets by processing a 3-bit active member address in the packet header. Further interaction between a master and a slave depends upon which of three types of master/slave communication links is established.

Bluetooth provides for low power operation across three different types of communications links. These link types are Synchronous Connection-Oriented (SCO), Extended Synchronous Connection-Oriented (eSCO), and Asynchronous Connection-Less (ACL). Synchronous links establish point-to-point links between a master and a single slave in the piconet. A master can manage up to three SCO links by using reserved slots at regular intervals. In SCO links, packets are never retransmitted, whereas eSCO links may have an additional retransmission window after the reserved transmission slots.

An ACL link may be a point-to-multi-point link between a master and all of the slaves participating in the piconet. A master can establish an ACL link on a per-slot basis to any slave, in transmission slots not reserved for the synchronous links. In ACL links, slave devices may enter a sleep state for a predetermined length of time. For example, the Bluetooth protocol implements a low power technique (sniff mode) for slaves which participate on ACL links. Sniff mode reduces the number of the time slots in which the master can start transmission to a specific slave. The master can start transmission only in specified time slots, called sniff slots. These sniff slots are spaced regularly within a time interval (T_{sniff}). The slave in sniff mode starts listening for sniff slots after a predetermined delay (D_{sniff}).

Despite improved power consumption characteristics, such operations do not satisfy the power requirements of a multitude of wireless devices and applications with low power requirements. Thus, many devices (such as sensors) were originally unable to implement Bluetooth capabilities due to prohibitively high power consumption requirements and implementation costs. To address this issue, Bluetooth Low End Extension (BT LEE) has been developed as an addition to “regular” Bluetooth. BT LEE involves wireless protocols allowing communications between devices having limited power resources. Thus, BT LEE offers significant power and cost reductions over Bluetooth wireless devices.

As a Bluetooth extension, BT LEE may utilize at least the analog parts of the Bluetooth radio. Unlike “regular” Bluetooth, BT LEE does not implement a frequency hopping routine or a transmission slot system. This results in a simpler, less complex system than a standard Bluetooth implementation. For instance, BT LEE divides the communication frequency band into a multitude of communication channels.

BT LEE is labeled as “low-end radio”. Various references address low-end radio. For instance, short range low-end radio is discussed in U.S. Pat. No. 6,944,457. Also, U.S. patent application Ser. No. 10/224,768 involves a low power solution utilizing an optimized combination of carrier sensing and frequency division multiple access to avoid collisions.

Future mobile terminals may carry several complementary access radios. These access radios may include multiple short-range radios as well as longer range (e.g., cellular) radios. Some of these radios may employ low end (e.g., BT LEE) techniques to communicate with remote low power consumption devices. However, communicating with a large number of such devices may be both time and power consuming for these terminals.

For instance, BT LEE communications involve a terminal polling each remote device individually and defining times in which a device may transmit data. When many remote devices are involved, little time may be left over for communications according to other transmission modes (e.g., regular Bluetooth). Accordingly, technical issues currently exist in providing devices with the ability to engage in multimode communications.

Currently, the IEEE 802.15.4 Wireless Personal Area Network (WPAN) Task Group is trying to resolve such issues through the use of a guaranteed time slot (GTS) concept in slotted beacon intervals. However, for multiple mode devices (e.g., devices supporting both Bluetooth and BT LEE), this concept does not offer a way for GTS periods to be defined so that multiple mode support can be arranged. Also, such GTS periods are very limited and time usage is not very flexible. For instance, allocation is always unidirectional (i.e., either receive or transmit).

Moreover, there are only seven GTS periods addressable during a single beacon interval. Thus, if more GTS periods are needed, several beacons have to be utilized. This increases the terminal's power consumption. Furthermore, GTS periods require allocation through a carrier sense multiple access with collision avoidance (CSMA/CA) routine, and must be deallocated when no longer used.

In light of the above, flexible and efficient techniques are needed for providing devices with the ability to employ multiple transmission modes.

### SUMMARY OF THE INVENTION

The present invention provides a method that allocates a plurality of polling response transmission times for a corresponding plurality of remote devices. The remote devices operate according to a first wireless transmission mode, such as Bluetooth LEE. These allocated polling response transmission times are outside of a time interval designated for communications according to a second wireless transmission mode, such as Bluetooth. Each of the polling response transmission times may be offset from a polling packet transmission time by a corresponding delay interval.

The method also transmits a polling packet to the plurality of remote devices and receives one or more responses to the polling packet. Each of these responses is sent by one of the remote devices during its corresponding polling response transmission time. In addition, the method may also communicate according to the second wireless transmission mode during the designated time interval.

In allocating the polling response times, the method may, for each remote device, send a request to the remote device. This request asks the remote device to move from an active mode to a low-activity mode (e.g., Bluetooth LEE sniff mode) and includes the polling response transmission time corresponding to the remote device.

In addition to the above features, the method may include an indication in the polling packet that identifies whether transmissions from each of the remote devices have been previously received.

Polling response times may be allocated in various ways. For instance, allocation may include, for each of the plurality of remote devices, setting the corresponding polling response transmission time to a particular value when the designated device is a first polled device among the plurality of remote devices. However, when the designated device is a subsequently polled device among the plurality of remote devices, a different approach may be taken. For example, a potential response transmission time for the designated device may be generated. This potential response transmission time is set as the polling response transmission time when a polling response transmission according to the potential response transmission time would be outside of a time interval designated for communications according to the second wireless transmission mode.

The present invention also provides devices and systems exhibiting the above features. Further features and advantages of the present invention will become apparent from the following description and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a operational mode diagram illustrating the various transitions between operational modes associated with an optimized low-end radio device;

FIGS. 2A and 2B illustrate two distinct optimized low-end radio communication link topologies;

FIG. 3 is an exemplary operational flow diagram of an embodiment of the present invention, in which a polling advertising device attempts to establish a communication link with a polled user device;

FIGS. 4A and 4B are exemplary operational flow diagrams involving role. switching features;

FIGS. 5A and 5B are operational state diagrams of optimized low-end radio devices implementing a continuous data transfer polling protocol for the polling and polled devices, respectively;

FIG. 6 is an exemplary operational flow diagram illustrating a symmetrical polling protocol in a low activity mode;

FIGS. 7A and 7B are operational state diagrams of optimized low-end radio devices implementing a low activity mode for the polling and polled devices, respectively;

FIGS. 8A and 8B illustrate an exemplary operational flow diagram of an asymmetrical low activity (sniff) mode, wherein the polled device enters an extended sleep state based on receipt of an acknowledgement from the previous polling sequence;

FIGS. 9A and 9B illustrate an exemplary operational flow diagram of the embodiment shown in FIGS. 8A and 8B, wherein the polled device enters an extended sleep state when the polling device completes a data transfer;

FIG. 10 illustrates an exemplary operational flow diagram, wherein the devices modify the sniff interval;

FIG. 11 is an operational flow diagram of a polling device managing multiple communication links in a low activity mode optimized low-end radio devices implementing a low activity mode for the polling and polled devices, respectively;

FIG. 12 is a diagram of an environment in which a terminal engages in wireless communications according to multiple transmission modes;

FIG. 13 is a flowchart of an operation that a terminal may employ for assigning operational parameters to one or more sensors/devices;

FIG. 14 is a diagram of a sequence of transmissions, according to embodiments of the present invention;

FIG. 15 is a flowchart of a terminal operation, according to embodiments of the present invention;

FIG. 16 is an exemplary ACK mask, according to embodiments of the present invention;

FIG. 17 is a diagram of a device architecture, according to embodiments of the present invention;

FIG. 18 is an exemplary implementation of a wireless communications device according to embodiments of the present invention; and

FIG. 19 is a diagram illustrating a sniff subrating feature according to embodiments of the present invention.

### DETAILED DESCRIPTION OF THE PREFERRED EMBODIMENTS

I. Low End Radio

The techniques described herein are directed to reducing power consumption, while maintaining communication links between short range wireless devices. Such devices may communicate using a variety of communication protocols, such as low end radio protocols. Bluetooth low-end extension (BT LEE) is an example of such a protocol. Accordingly, the examples provided herein are described in the context of Bluetooth LEE. However, other protocols may be employed. For instance, ZigBee is an example of such other protocols. ZigBee provides a set of communication protocols designed to use small, low power digital radios that are based on the IEEE 802.15.4 standard for wireless personal area networks (WPANs). These protocols provide for the creation of low data rate ad-hoc and mesh networks. Such networks utilize direct sequence spread spectrum (DSSS) transmissions within the ISM band. ZigBee networks are aimed at low power consumption so that devices may operate on batteries for long periods of time. ZigBee networks typically include a single ZigBee coordinator device. Moreover, ZigBee provides for full function devices (FFDs), and reduced function device (RFDs). The software for RFDs requires relatively little storage space.

Generally, devices implementing optimized low-end radio protocols are wireless devices that have a transmitter, a receiver, a processor, memory, and may include any number of either consumer, commercial, or industrial electronic devices.

Communications between devices according to Bluetooth LEE involve two types of packet structures: identification packets and general packets. However, in alternate embodiments, communications between devices may involve other forms of wireless communication, such as analog communications. General packets are used for data and control information. The same header structure is employed for all general packets. However, the payload length for general packets is variable (up to 255 bytes). One type of general packet is an ID_INFO packet, which is used to establish connections between local and remote devices within a communication coverage range.

The present invention provides techniques in which communications links optimized for low power consumption are established between devices that are within communications range of each other. Low-end radio (LER) devices (e.g. Bluetooth LEE devices) may establish communications link also between multiple devices. In these environments, one device assumes a polling device role, while the other devices assume a polled device role. Advantageously, each device is capable of assuming either the polling role or the polled role.

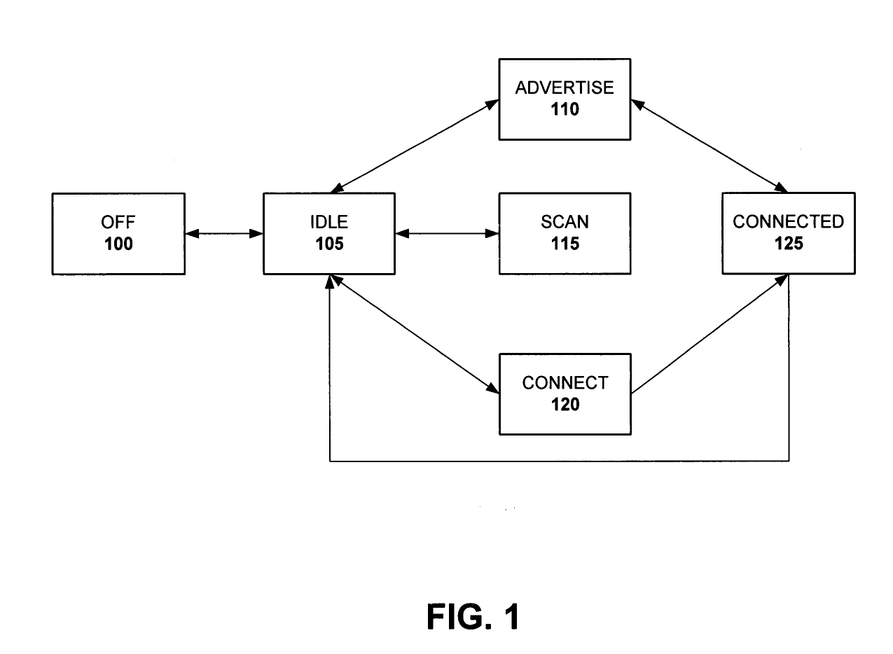

FIG. 1 is a connectivity state diagram illustrating the operational modes of a BT LEE device. A device may initially start in the off mode 100. A user activates the device and moves the device into the idle mode 105. Depending on the device application, the device may move from idle mode 105 to an advertise mode 110, scan mode 115, or connect mode 120.

The local device's connectivity mode is application-dependent. The advertise mode 110 makes the local device visible to other devices within a communication coverage range. A local device in the advertise mode may be constrained to communicate with a limited subset of devices. BT LEE, enables the possibility of an application-dependent tradeoff between connection set-up time and power consumption. For example, a device in advertise mode 110 consumes power and time determining whether there are any connectable devices within a coverage area.

After determining, that there is at least one desirable connectable device present, the device in advertise mode consumes additional power connecting to any of the user-specified devices. In contrast, a device in connect mode 120 attempts to connect with a specific advertising remote device and does not consume power or time determining whether there are other connectable devices within a coverage area. In scan mode 115, a local device collects addresses and short descriptions from one or more advertising remote devices within a communication coverage range.

When a local device enters the connect mode 120, the local device attempts to establish a point-to-point, bi-directional data delivery with possible error detection, and Automatic Repeat-ReQuest message (ARQ). As illustrated in FIG. 1, a local device may, in turn, move to the connected mode 125 from either the advertise mode or the connect mode. As the connected mode is terminated, the device will either enter the advertise mode or the idle mode. The next mode is selected by an upper layer. A local device in the connected mode 125 may selectively enter a particular operational mode (e.g., an active mode or a low activity mode). The low activity mode (low power mode) may also facilitate a switch from a point-to-point operational topology to a point to multi-point operational topology, for devices that are capable of acting as polling devices in multiple connections.

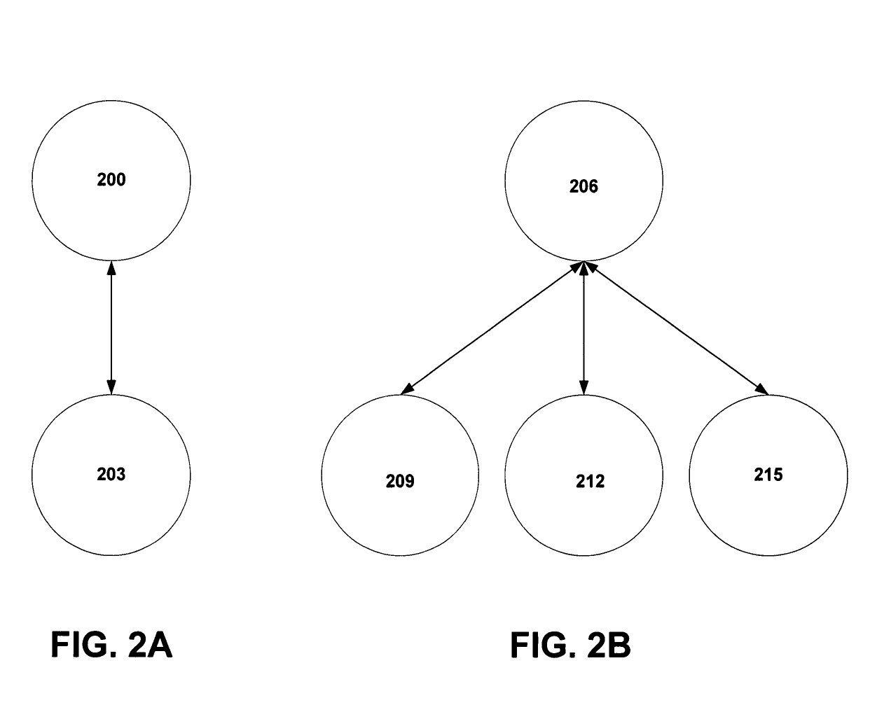

FIGS. 2A and 2B schematically illustrate local devices communicating in a point-to-point operational topology and a point-to-multi-point topology, respectively. As shown in FIG. 2A, the polling device 200 is in the connected mode 125 communicating with polled device 203 in a point-to-point topology. In FIG. 2B, polling device 206 establishes a point-to-multi-point connection topology with polled devices 209, 212, and 215. Generally, in order to facilitate communication management, devices in a point to multi-point connection may implement an asymmetrical low activity polling protocol.

The operations and functionality illustrated in the figures are accomplished by advertising devices and user devices. The advertising devices advertise data or information for subsequent data transfers. The user devices receive and process the data or information. Accordingly, implementations of such devices may include components, such as transmitters, receivers, and processors. Such processors may be operatively programmed to transmit, receive, and process the messages exchanged between devices, as well as execute the functionality associated with the exchanged messages as described herein and shown in the drawings.

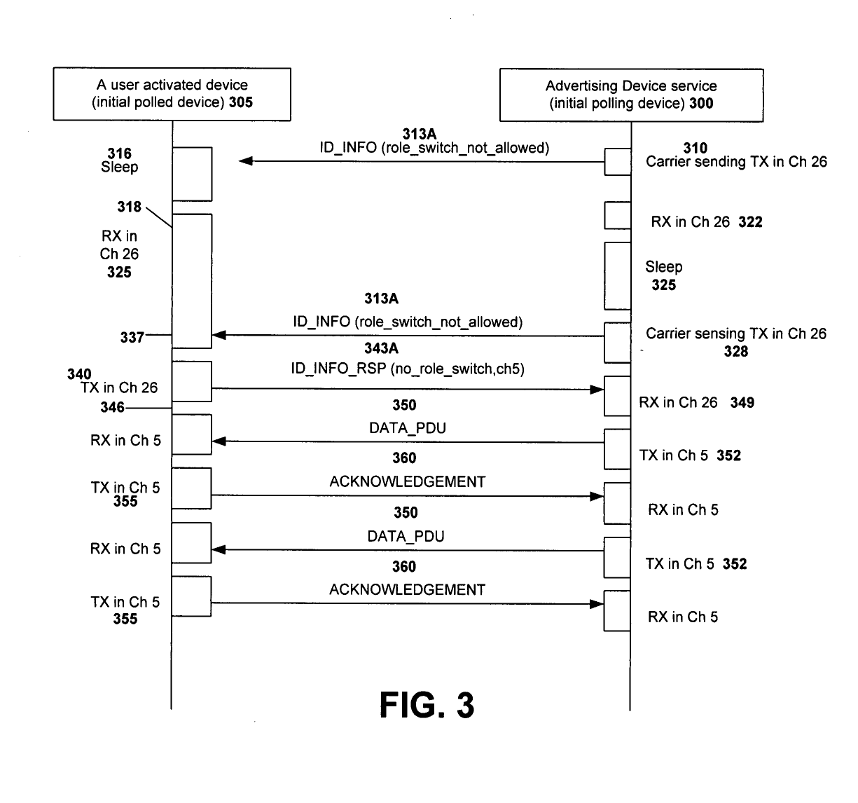

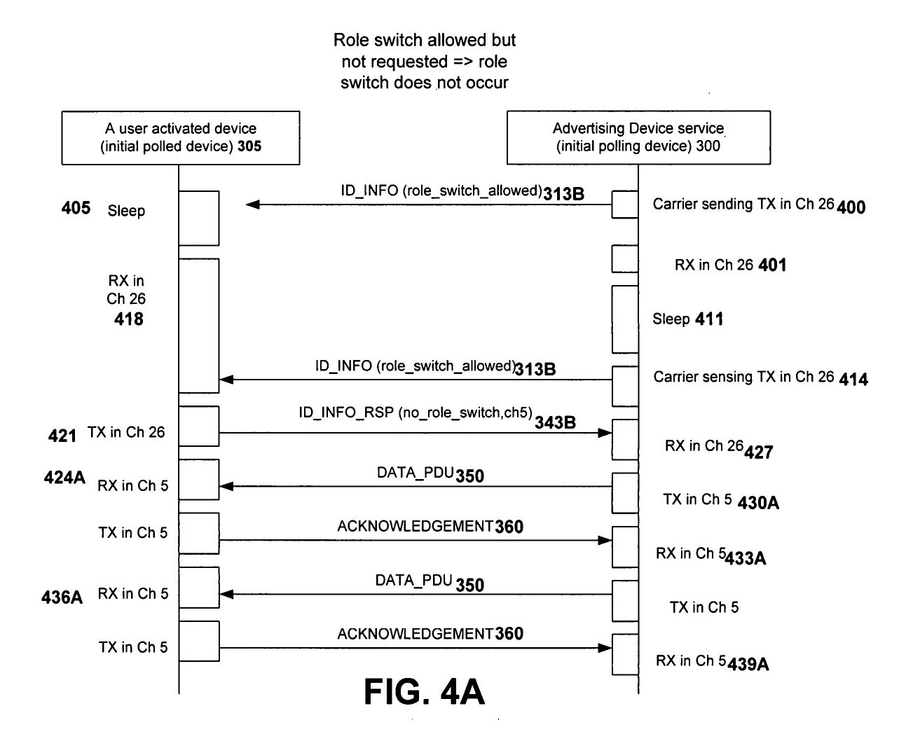

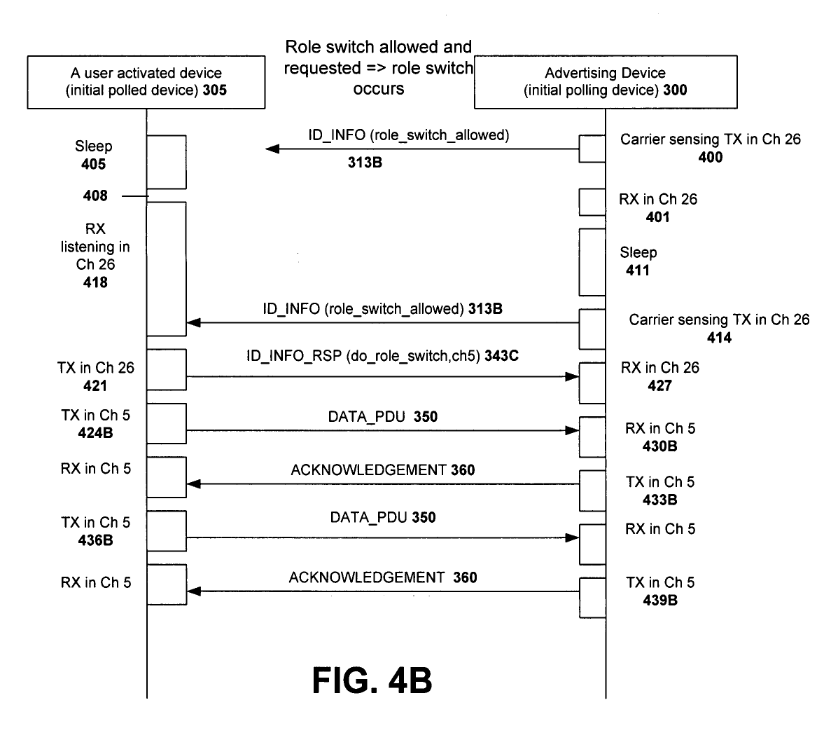

For example, two BT LEE devices communicating in a point-to-point topology are capable of negotiating device control roles as the devices establish the communication link. Specifically, to increase power consumption savings, a user device may initiate a polling device role exchange (polling role switching). In this role exchange, the user device (initial polled device) assumes the role of the polling device and the advertising device (the initial polling device) assumes the polled device role. FIG. 3 illustrates two BT LEE devices establishing a communication link with polling role negotiation disabled, whereas FIGS. 4A and 4B illustrate the BT LEE devices with polling role negotiation enabled.

BT LEE divides, according to embodiments of the present invention, the range of available communication channels into advertising channels and data transfer channels. By way of example only, a device in advertise mode 110 periodically broadcasts an advertising message, ID_INFO, in one of three advertising channels, such as, for example channel 26, as the device advertises its availability to connect. The ID_INFO packet, sent by the polling device 300, contains the lower part of a 64-bit IEEE address and a service field. In turn, the service field may contain information about the device, for example: if the device allows connections to all the devices, if connection to certain devices are restricted, if users may purchase services associated with a LER device, if a particular LER device provides access to the internet, if the upper layer of the protocol stack has updated information, or if the LER device can facilitate polling role switching of connected devices as discussed below.

FIG. 3 also illustrates the operations associated with establishing a communication link between a device (polling device 300) that is advertising data or services and a user device (polled device 305). An advertising device periodically transmits a data message, ID_INFO, that may identify the type of services or information available. In the embodiment illustrated in FIG. 3, the advertising device transmits ID_INFO on a channel designated for advertising a device's availability for connection, (e.g., channel 26). If a user activated device is within communication range of the advertising device, it may respond by transmitting a response data message, ID_INFO_RSP. Some of the data elements within the ID_INFO_RSP packet may include the lower part of the 64-bit IEEE address of the polled device, the request for polling role switching, and/or the data channel to be used for any subsequent data transfers. The request for polling role switching in the ID_INFO_RSP packet is not relevant if there was a corresponding notice in the ID_INFO packet indicating that the advertising device has disabled polling role switching. If the ID_INFO packet does not indicate disabling role switching then the polling switching in the ID_INFO_RSP is relevant. However, the user device does not have to request polling role switching, if it was initially enabled by the advertising device in the ID_INFO packet.

FIG. 3 illustrates an operational flow diagram of two devices establishing a low-end radio communication link wherein polling role switching is disabled. After conducting carrier sensing on advertising channel 26 and determining the absence of conflicting transmissions (310), the polling device 300 transmits the ID_INFO packet 313A. Additionally, in order to conserve power, the devices may conduct carrier sensing before transmitting data once a communication link has been established. The polling device includes a polling role switching indicator within ID_INFO 313A to advise the polled device of the status of polling role switching.

As shown in FIG. 3, user device 305 is initially in a sleeping state (316) and therefore ignores the ID_INFO packet 313A transmitted. Accordingly, polling device 300 listens on channel 26 for a response over a predetermined length of time (322), but does not receive a response from the polled device. Before starting the sequence again with carrier sensing (328), the polling device 300 may itself, enter a sleep mode (325) for a predetermined length of time. The user may move polled device 305, from a sleeping mode into a listening mode (318) (e.g., a user moving a wireless mouse after an period of inactivity). Alternately, the polled device may be programmed to periodically move between sleep and listening states prior to establishing a communication link. The polled device 305 actively listens for the ID_INFO packet 313A during listening state. Coming out of its sleep mode (316), the advertising device repeats carrier sensing and retransmits the ID_INFO packet as 313A (328).

This time, the polled user device 305, which now is in the listening mode (318), receives and processes the ID_INFO packet at step (337). In step (340), the polled device 305 prepares and transmits on channel 26, a responding ID_INFO_RSP packet 343A, to acknowledge receipt of the ID_INFO packet 313A. The polled device 305 indicates in ID_INFO_RSP 343A that polling role switching is not enabled and also that subsequent communication should be carried out on a data transmission channel, in this example specifically channel 5.

After transmitting the ID_INFO_RSP packet 343A, the polled user device 305 switches to channel 5 (346) and begins listening for any data transmissions from the advertising device. Meanwhile, the polling device 300 receives and processes the ID_INFO_RSP 343A packet and switches to data transmission channel 5 (349), the data transmission channel designated by the polled device 305.

At this point, a communication link has been established. Subsequent communications between the polling device 300 and the polled device 305 involve transmitting a data packet, DATA_PDU 350, from the polling device 300 to the polled device 305 at step (352), and the polled device 305 responding by transmitting (355) an acknowledgement 360 on the data transfer channel, channel 5.

FIGS. 4A and 4B illustrate advertising device 300 and user device 305 establishing a communication link using a similar method as that illustrated in FIG. 3, except that the polling device's ID_INFO packet 313B includes an indicator that polling role switching is enabled. In FIG. 3, packet 313A illustrates the case when role switching is disabled. FIG. 4A illustrates advertising device 300 enabling the polling role switching indicator, whereas user activated device 305 denying polling role switching. In contrast, FIG. 4B illustrates advertising device 300 enabling the polling role switching indicator, while user activated device accepts polling role switching. For the purposes of the example in FIGS. 4A and 4B, advertising device 300 initially assumes the role of the polling device, as before, and user device 305 initially assumes the role of the polled device.

After conducting carrier sensing and determining the channel is clear for transmitting, the advertising device 300 attempts to initiate contact by transmitting the ID_INFO packet 313B on advertising channel 26. The advertising device 300 sets the role_switch_allowed flag in the packet ID_INFO 313B prior to transmission in step 400. After transmitting, the polling device moves to a listening (receive) state on channel 26 (401). As in FIG. 3, the user device 305 also initially is in a sleep state (405) and therefore does not respond to the ID_INFO packet 313B. Subsequently, the user device 305 moves during interval 408 from sleep state into a listening state 418. Having received no response from a polled device, the advertising device 300 also enters a sleep state for a predetermined length of time (411), at the end of which it retransmits the ID_INFO packet 313B at step (414). Since the user device 305 is at that particular moment in a listening state, it receives and processes the ID_INFO packet (418).

In FIGS. 4A and 4B, the advertising device 300 provides the user device 305 with the opportunity to switch roles, wherein the user device may move from the polled device role to assume the polling device role. Likewise, the advertising device may move from the polling device role to assume the polled device role.

In FIG. 4A, user device 305 prepares and transmits the ID_INFO_RSP packet 343B on advertising channel 26 (421). In the ID_INFO_RSP packet 343B, user device 305 confirms that subsequent data/service transfers will occur on channel 5. Also, user device 305 indicates in ID_INFO_RSP packet 343B that the devices will not switch roles—user device 305 remains the polled device and advertising device 300 remains the polling device. Accordingly, after receiving and processing ID INFO_RSP 343B, advertising device 300 prepares and transmits DATA_PDU 350 on the designated data transmission channel in step (427). User device receives DATA_PDU 350 in step (421) and transmits ACKNOWLEDGEMENT 360 in response in step (424). The DATA_PDU/ACKNOWLEDGEMENT exchange process occurs until the communication link is terminated (i.e., the devices exit the connected state).

In FIG. 4B, user device 305 transmits ID_INFO_RSP 343C, indicating that polling role switching is accepted. Accordingly, user device 305 (the initial polled device), assumes the role of the polling device by transmitting DATA_PDU 350 in steps (424B) and (436B). Similarly, advertising device 300, the initial polling device, assumes the role of the polled device receiving the DATA_PDU 350 and transmitting ACKNOWLEDGEMENT 360 in steps (433B) and (439B).

As noted earlier, BT LEE devices that have established a wireless communication link and entered the connected state 125, as shown in FIG. 1. Devices in this state may operate in two distinct operation modes—either in an active mode, or in a low activity mode. The active, or continuous data transfer, mode involves two devices implementing a periodic polling protocol, such as those illustrated in FIGS. 3 and 4.

Devices in the low activity mode (also referred to as a “sniff” mode) can operate according to either a symmetrical low activity mode or an asymmetrical low activity mode. An LER device may enter the symmetrical low activity mode, in which the advertising device and the user device enter a sleep state for the same predetermined duration between successive poll/acknowledgement sequences. In the asymmetrical low activity mode, the polling device and the polled device enter sleep states that have different durations. While in the sleep state, the polled device does not respond to a predetermined number of polling messages from the polling device. However, the polled device may respond earlier to the polling messages, if it has data to send.

The polling frequency used for either, or both, the active and low activity modes may be either predetermined or dynamically determined. In either event, the devices tune to the data transfer channel, where one device periodically polls the other. In response, the polled device transmits an acknowledgement. This process continues until one of the devices disconnects.

The data transfer and acknowledge transmission steps 352 and 355 in FIG. 3 are operations associated with devices in the active mode. According to these operations, once a communication link is set up, two devices continuously exchange data packets on a data channel according to a polling protocol. Accordingly, the polled device may only transmit packets in response to receiving a transmission from the polling device. As illustrated in FIGS. 3 and 4, the polling device transmits a DATA_PDU packet 350 to the polled device, and the polled device responds by transmitting an ACKNOWLEDGEMENT_PDU packet 360. Both of the packets have the same format and may have a payload up to 255 bytes. If the polled device does not acknowledge the DATA_PDU packet 350, as occurs in the protocols of FIGS. 3 and 4, the polling device may retransmit the packet after a predetermined or variable timeout, depending on the application.

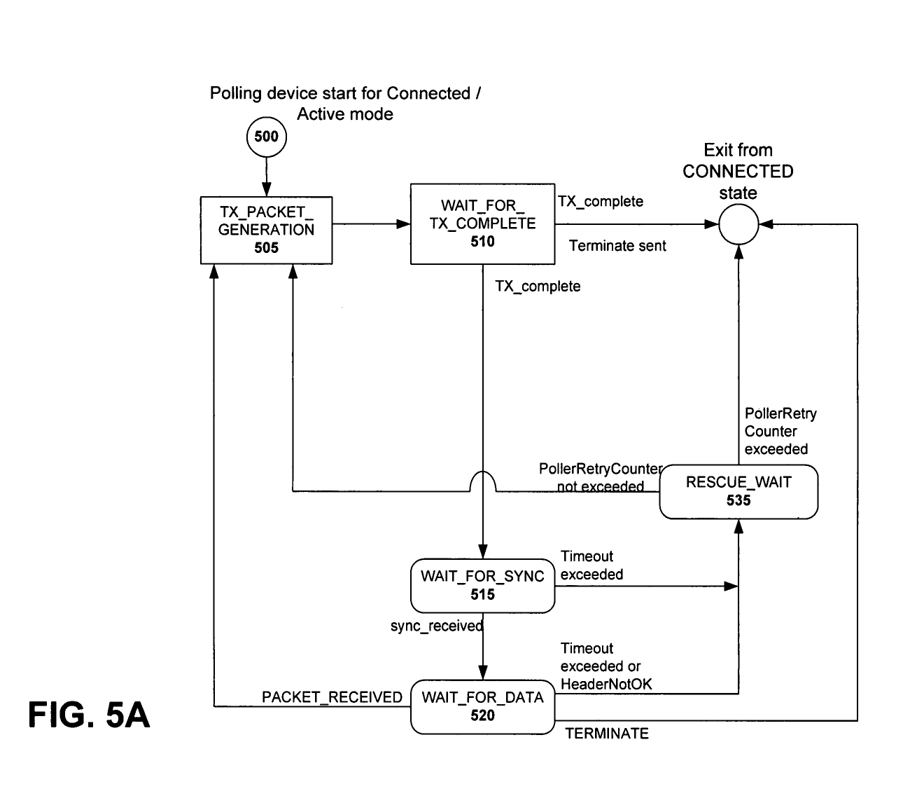

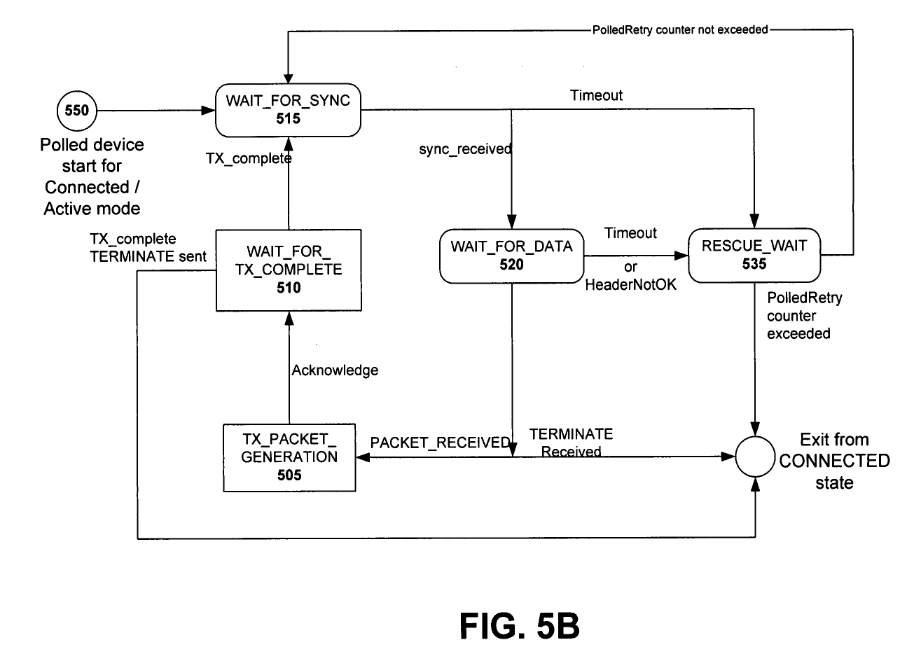

FIG. 5A is a diagram showing internal operational states through which a polling device 500 may move in a connected/active mode. Initially, polling device 500 generates the DATA_PDU packet in the TX_PACKET_GENERATION state 505 and transmits the packet on the data channel during the WAIT_FOR_TX_COMPLETE state 510. If the polling device 500 transmits a terminate message, it may exit from the CONNECTED state. If the polling device 500 transmits a packet other than the terminate message, the polling device 500 may move to WAIT_FOR_SYNC 515 and wait to receive packet synchronization bits transmitted from the polled device (550 in FIG. 5B), which are transmitted by the polled device prior to the packet header of the ACKNOWLEDGEMENT_PDU. Once the synchronization bits are received, the polling device 500 moves to the WAIT_FOR_DATA state 520 to wait for the rest of the acknowledgement packet. If the terminate message has been received, the polling device 500 moves to exit from CONNECTED state. Otherwise, the polling device 500 moves to TX_PACKET_GENERATION 505 to transfer additional data.

FIG. 5B is a diagram showing various states of the polled device 550 in the connected/active mode. Assuming that the polled device 550 is listening for a transmission from another device, it is in the WAIT_FOR_SYNC state 515. In normal operation, the polled device 550 moves from the WAIT_FOR_SYNC state 515 to the WAIT_FOR_DATA state 520, as with the polling device. Upon receipt of the polling message (e.g., ID_INFO), the polled device 550 moves to the TX_PACKET_GENERATION 505 state to create an acknowledgement response message. This message is transmitted in the WAIT_FOR_TX_COMPLETE state 510. Upon successfully transmitting the acknowledgement message, the polled device 550 then has two options. These options are: (1) exit from the CONNECTED state, if the polled device transmitted the terminate message, or otherwise, (2) move back to the initial WAIT_FOR_SYNC state 515 to wait for more data from the polling device 500. If the polled device received a terminate message from the polling device in WAIT_FOR_DATA state, it exits from the CONNECTED state.

FIGS. 5A and 5B also illustrate that the communicating devices incorporate both error detection and recovery states in the connected/active mode. An internal counter is initialized whenever the respective devices enter the WAIT_FOR DATA or WAIT_FOR_SYNC states. If the counter exceeds a timeout duration, the device has not received the expected packet, or if the packet header is not OK, the device may move into a RESCUE_WAIT state 535. Device controllers respectively implement two counters to count the sequential non-received packets—(i) PollerRetryCounter 540 and (ii) PolledRetryCounter 541. Each time a device moves into the RESCUE_WAIT state 535, the corresponding counter is incremented. The counter is reset after successful packet switch. After incrementing the counter's value, the device moves back to its respective initial state for the particular device, i.e., TX_PACKET_GENERATION 505 for the polling device and WAIT_FOR_SYNC 515 for the polled device. If the counter exceeds a predetermined threshold corresponding to the number of consecutive packets lost, the device exits from the CONNECTED state and terminates the connection. After terminating the connection, the device moves back to either advertising mode 110 or idle mode 105 (FIG. 1). Otherwise, if the Poller/PolledRetryCounte- r is not exceeded, a device may move back to the initial TX_PACKET_GENERATION (FIG.5A) or WAIT_FOR_SYNC (FIG. 5B). The device moves back to the mode it was in before entering the connected mode 125.

As described above, a device may alternatively be connected in a low activity mode (sniff mode), which enables a slower, but periodic data packet exchange between connected devices. As will be described below, the greater lengths of time associated with periodic communications between a polling device and a polled device, facilitate maintenance of the communication link, while decreasing power consumption. These embodiments achieve data transfers that are faster than if two unconnected devices have to establish a communication link anew in order to transfer data.

Once the polling roles are established, the devices may transfer the data according to a polling protocol, (e.g. active or continuous data transfer mode, symmetrical low activity mode, or asymmetrical low activity mode). Either the polling device, or the polled device in the active mode, may initiate a move to the low activity mode. Also, either device may modify the low activity parameters when the devices are in low activity mode. Specifically, to initiate a move to the low activity mode, a device transmits a sniff request packet, which shares the same general packet format as the packets used in the other operational modes discussed above. The payload, however, contains several low activity mode indicators SNIFFINTERVAL (sniff interval), MAXRSPINTERVAL (maximum response interval), MAXPAYLOAD (maximum payload), and FIXEDSIZEPAYLOAD (fixed size payload).

The SNIFFINTERVAL is an 8-bit field defining the polling interval. Depending on the application, the interval may be calculated through an equation, for example, (2ˆ(x+1)+2*y)*3*0.625 [ms], where x is the four most significant bits of the field, and y represents the four least significant bits. The MAXRSPINTERVAL is an 8-bit field defining the number of ignorable poll packets (i.e. the number of consecutive polling messages to which the polled device does not need to prepare and transmit a response).

The MAXPAYLOAD is an 8-bit field defining the maximum allowable packet payload in bytes during the low activity mode. Finally, the FIXEDSIZEPAYLOAD, a 1-bit field, defines whether or not all of the transmitted and received packets will be the same size. In the event that the FIXEDSIZEPAYLOAD indicator is enabled, the payloads of all packets will correspond to the MAXPAYLOAD value.

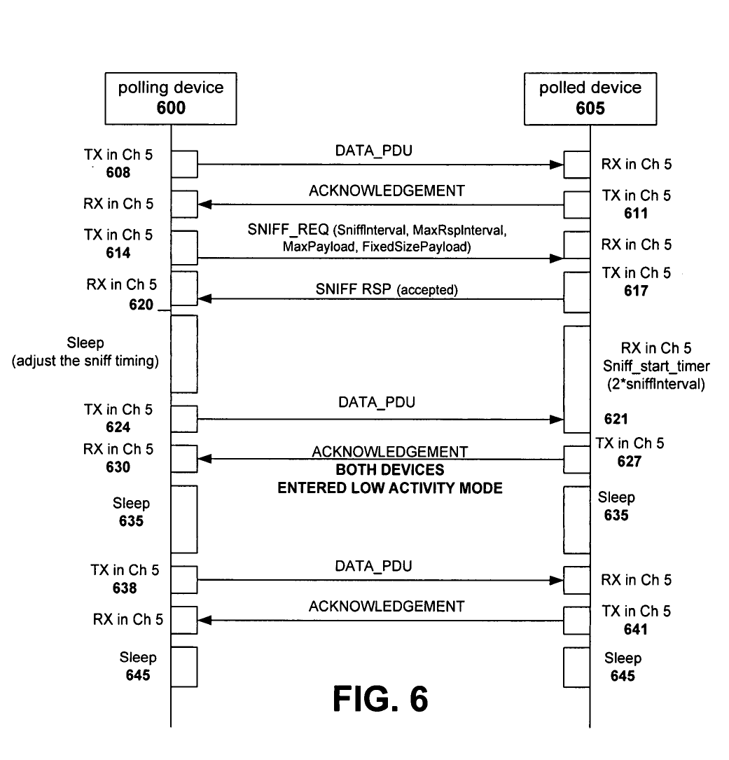

FIG. 6 illustrates an operational flow diagram of two devices implementing the symmetrical low activity mode. Initially, a polling device 600 and a polled device 605 may transmit data packets and acknowledgements as shown (608, 611) in the manner previously described. Either device may initiate the move to the low activity mode (sniff mode). In the embodiment illustrated in FIG. 6, the polling device 600 prepares and transmits to the polled device a low activity (sniff) request (614) containing the parameters discussed above. The polled device 605 prepares and transmits a sniff response accepting the transition request (617).

In accordance with the sniff request and response, the polling device enters a sleep mode to establish the sniff timing (620). The polling device 600 may use this initial sleep period to coordinate the low activity mode connection with polled device 605 and with any other low activity connections that the polling device 600 may be managing. The polled device 605 initiates a low activity mode (sniff) timer and awaits receipt of the first low activity mode transmission (621). Accordingly, the polling device 600 prepares and transmits the first sniff data packet DATA_PDU (624).

The sniff data packets may be transmitted according to a fixed-time interval with the interval starting with the completion of the transmission of the polling message. The polled device 605 receives this initial sniff data packet and responds by transmitting an acknowledgement (627). The acknowledgement is received and processed by the polling device 600 (630). The devices have now entered low activity mode, and both enter a sleep mode corresponding to a sniff interval (635). The devices wake from the sleep mode with the polling device 600 conducting a data transfer (638) and the polled device 605 transmitting an acknowledgement (641). After the data transfer/acknowledgement, the devices once again enter the sleep mode (645). The symmetrical sleep states with both devices sleeping for an equal duration are indicative of the symmetrical low activity mode.

Generally, during a low activity mode connection, the device polling roles remain the same as determined during the connection setup. In the low activity mode, the devices may enter a sleep state between completed data transfer/acknowledgement sequences to conserve power. Under the circumstances discussed below, a polled device in an asymmetrical low activity mode may enter an extended sleep state.

In order to enter low activity mode, either device may prepare and transmit a new sniff request with a new set of sniff parameters at any time the devices are connected. This may be, for example, after a data transfer has occurred. A sniff request (e.g., by setting all of the sniffinterval bits to one), may terminate the low activity mode connection. Depending on the application, the connection between devices may be terminated, (i.e., stopped) or the connection may revert to active mode (i.e., continuous data transfer). The connection in low activity mode terminates in a manner similar to the active mode—due to the transmission or reception of a termination message or due to an error condition (no packets received).

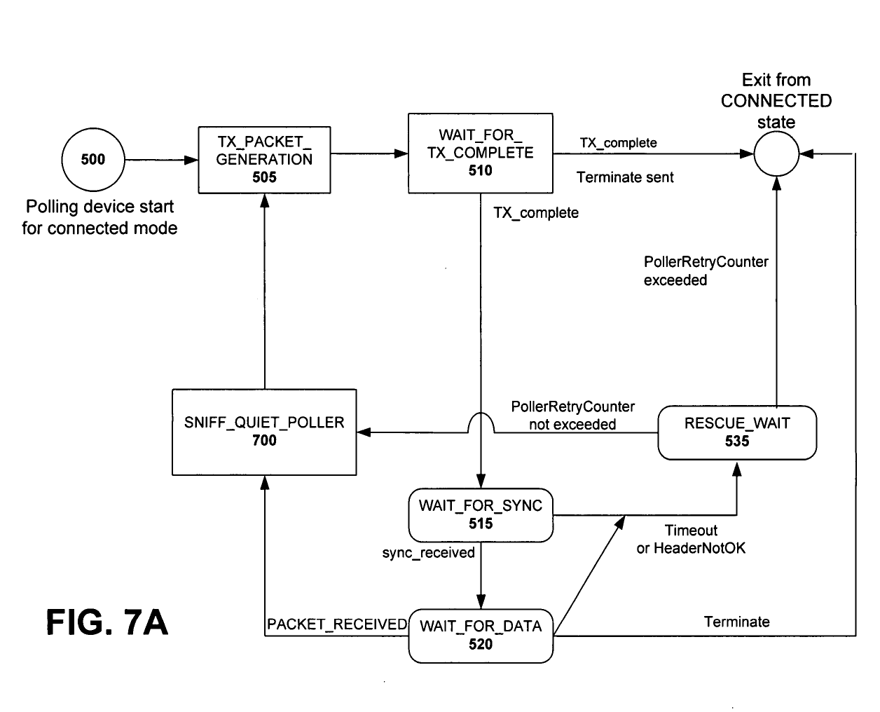

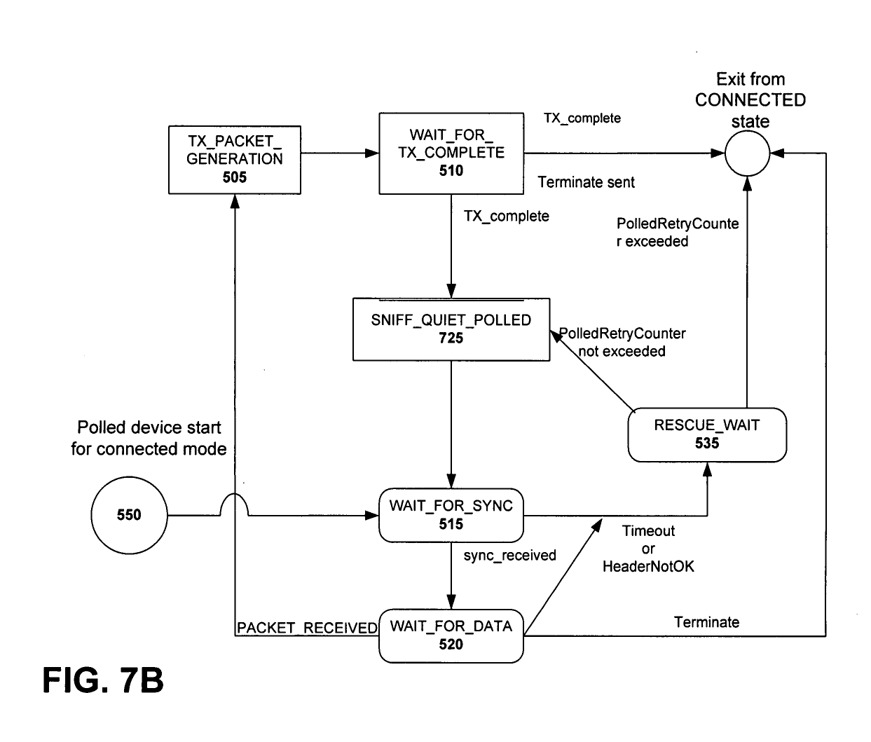

FIGS. 7A and 7B illustrate the operational states and the transitions between states for polling devices in the low activity mode. The states are the same as those discussed in connection with FIG. 6 with the exception of two additional device-specific states. These states are SNIFF_QUIET_POLLER 700 (polling devices) in FIG. 7A and SNIFF_QUIET_POLLED 725 (polled devices) in FIG. 7B.

The polling device 500 enters the SNIFF_QUIET_POLLER state 700 in FIG. 7A, after it has received a packet from the polled device, or after the following error cases from the RESCUE_WAIT 535 state: the polling device (1) has received a packet with a bad packet header or (2) timed out while trying to receive a packet from the polled device 550 in WAIT_FOR_DATA 520. In FIG. 7B polled device 550 enters SNIFF_QUIET_POLLED 725, either after it has transmitted its packet in WAIT_FOR_TX_COMPLETE 510, or from the RESCUE_WAIT 535 state if it has not received the polling message. Devices operating in the “SNIFF” state usually enter a sleep mode in the SNIFF_QUIET_POLLED/POLLER states. During low activity mode, the devices may enter the sleep state, or alternately, may establish and maintain connections with other devices. It is easier for the polling device to manage multiple connection. Alternately, if devices are in the low activity mode, the polling device 500 may establish a connection or communicate with another polled device.

The connection in low activity mode terminates in the method described above, for example, by sending a sniff request with all sniff interval bits set to one, or when a device fails to respond to repeated to polling retransmissions. The device in the RESCUE_WAIT state 535 terminates the connection, if the PollerRetryCounter value shown in FIG. 7A, or the PolledRetryCounter shown in FIG. 7B, exceeds a termination threshold and exits the CONNECTED state. If the counter values do not exceed the termination thresholds, the polling device in FIG. 7A moves to SNIFF_QUIET_POLLER 700, whereas the polled device in FIG. 7B moves to SNIFF_QUIET_POLLED 725.

In a symmetrical low activity connection, as illustrated in FIG. 6, the polled device should receive and respond to each polling packet (MAXRSPINTERVAL=0). However, in an asymmetrical low activity connection, the polled device does not have to respond to each polling packet. The number of packets that the polled device may ignore is equal to the value of the MAXRSPINTERVAL sniff parameter. For a low activity device, the polling device increases its polling retry counter only after it has not received a number of responses that corresponds to the value of the MAXRSPINTERVAL.

The symmetrical low activity mode is useful in applications, for example, where the polling device frequently sends control data. In contrast, asymmetrical low activity mode is useful in applications where polled devices do not have periodic data to send or do not need to receive data on a regular basis. Several examples of asymmetrical devices may include wireless mice, keyboards and remote controllers. Generally, these devices transmit data if a user provides a direct input to the device. The inputs may be time critical. Therefore, it is worthwhile to maintain a connection and avoid the time associated with establishing a new connection.

Polling devices, such as personal computers or televisions generally do not rely on low power operability in the same way a wireless mouse or headset would. Accordingly, such polling devices are able to maintain a relatively high polling frequency, so that when the polled device does respond, the data transfer rate is relatively fast, as compared with establishing a new connection and transferring the data.

During asymmetrical low activity mode, there are two instances in which a polled device may not enter an extended sleep state. When the polled device responds to the polling device, the polled device must acknowledge any received additional polling packets if either of two conditions is true (1) the payload packet is not empty or (2) the poll packet contains a negative acknowledgement (NACK). A non-empty Poll PDU payload signifies that the polling device is currently transmitting data. A NACK indicates that the polling device has not received an error free response to previous Poll PDU. If neither of these conditions (payload not empty or NACK) is true, then the polling device has completed the data transfer or has indicated that the acknowledgement sent by the polled device in response to the previous polling message was properly received, and the polled device may now enter an extended sleep state.

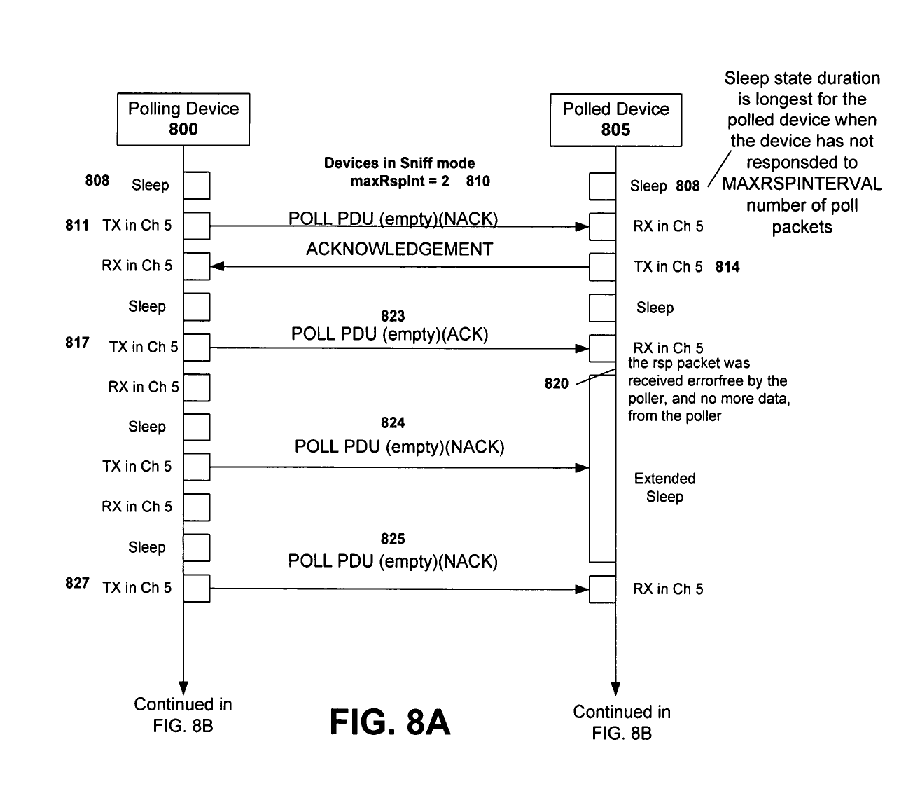

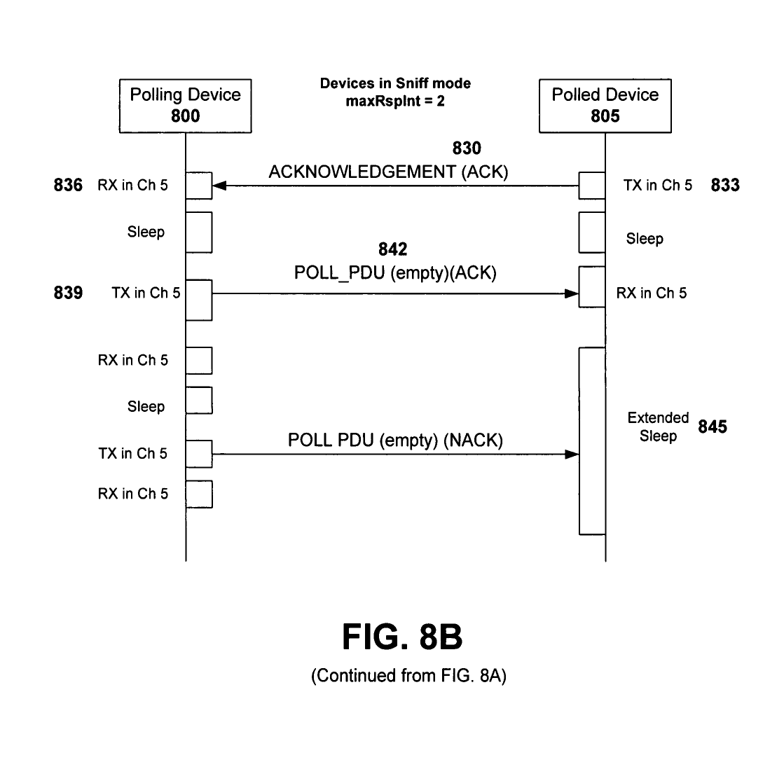

FIGS. 8A and 8B are an operational flow diagram of an asymmetrical low activity mode communication link between polling device 800 and polled device 805. In FIG. 8A, the polling device 800 and polled device 805 are initially in a sleep state 808. In this mode, each device sequences through the transmit (TX), receive (RX), and sleep states, each of which may have a predefined duration. The polled device, however, may extend its sleep periods—in accordance with the parameters agreed upon. Polling device 800 transmits a Poll PDU with an empty payload and a NACK at step (811). As discussed above, the polled device must prepare and transmit an acknowledgement (814), because the NACK indicates that the polled device's response to the previous Poll PDU was not received.

The polling device 800 transmits an empty payload in the Poll PDU, but includes a positive acknowledgement indicator (ACK) (817). The ACK indicates that the previous polled device response packet was properly received by the polling device 805. The ACK, in coordination with the empty data payload, enables the polled device 805 to enter an extended sleep state 820, as noted above, during which it ignores a predetermined number 810 (MAXRSPINTERVAL value=2) of polling device Poll PDUs. For example, assuming the MAXRSPINTERVAL value 810 associated with the embodiment illustrated in FIG. 8A is two, the polled device 805 does not have to respond to the two Poll PDUs 823 and 824. However, polled device 805 should be ready to receive and acknowledge the next Poll PDU 825.

Continuing with FIG. 8B, the polled device 805 responds to a third Poll PDU 825 (from FIG. 8A). The polled device 805 transmits the ACKNOWLEDGEMENT 830 (833). The polling device 800 receives at step (836), the ACKNOWLEDGEMENT 830. It thereupon prepares the Poll PDU 842, indicating that the polling device does not have additional data to transfer and that ACKNOWLEDGEMENT 830 was properly received, and transmits Poll PDU 842 at step (839). Since Poll PDU 842 indicates that the payload is empty and the ACKNOWLEDGEMENT 830 was properly received, polled device 805 may enter an extended sleep state 845.

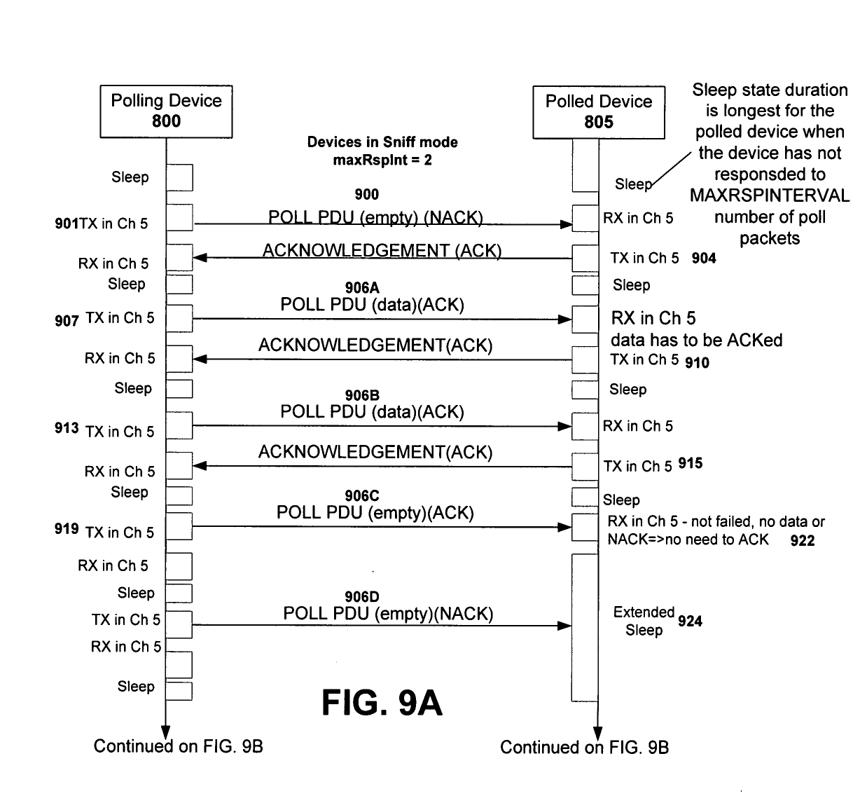

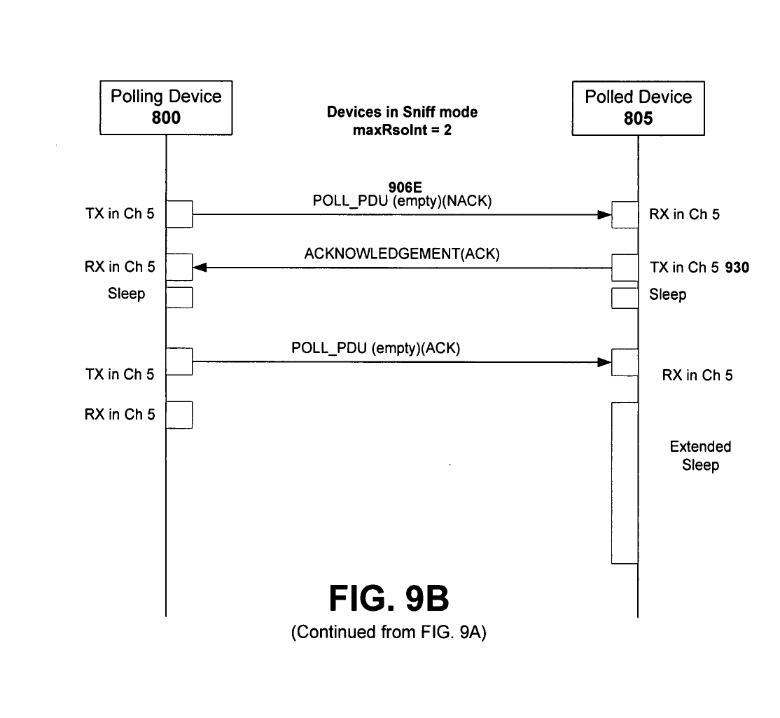

FIGS. 9A and 9B are an operational flow diagram of an asymmetrical polling protocol, where the polled device enters an extended sleep state after the polling device has finished transferring a block of data through two Poll PDU data transfers. Polling Device 800 prepares and transmits a Poll PDU 900, comprising an empty payload, and a NACK (901). Polled device 805 receives the Poll PDU 900, and transmits an ACKNOWLEDGEMENT, as required by the NACK indicator (904).

Polling Device 800 starts a data transfer (907), by transmitting a Poll PDU 906A with data in the payload. Polled device 805 transmits an ACKNOWLEDGEMENT, since data was transferred in Poll PDU 906A (910). Polled device 805 must actively receive any additional data that the polling device 800 may transfer during subsequent Poll PDUs, such as Poll PDU 906B transmitted by the polling device 800 at step 913. After receiving the transferred data, polled device 805 again issues an ACKNOWLEDGEMENT in step 915 and waits for additional data. Assuming polling device 800 transmits Poll PDU 906C with an empty payload at step 919, the polled device 805 processes the Poll PDU 906C at step 922 and determines that Poll PDU 906C has an empty payload and an ACK indicator. Therefore, polled device 805 may enter an extended sleep state (924). According to the MAXRSPINTERVAL value discussed above, the polled device 805 may ignore two Poll PDUs, including 906C and 906D. Thereafter, referring to FIG. 9B, polled device 805 must listen for the next Poll PDU 906E sent on data transfer channel 5. As discussed above, because no acknowledgement to the last Poll PDU was transmitted by the polled device 805, Poll PDU 906E includes a NACK indicator. Therefore, the polled device 805 must in this instance now acknowledge receipt (930).

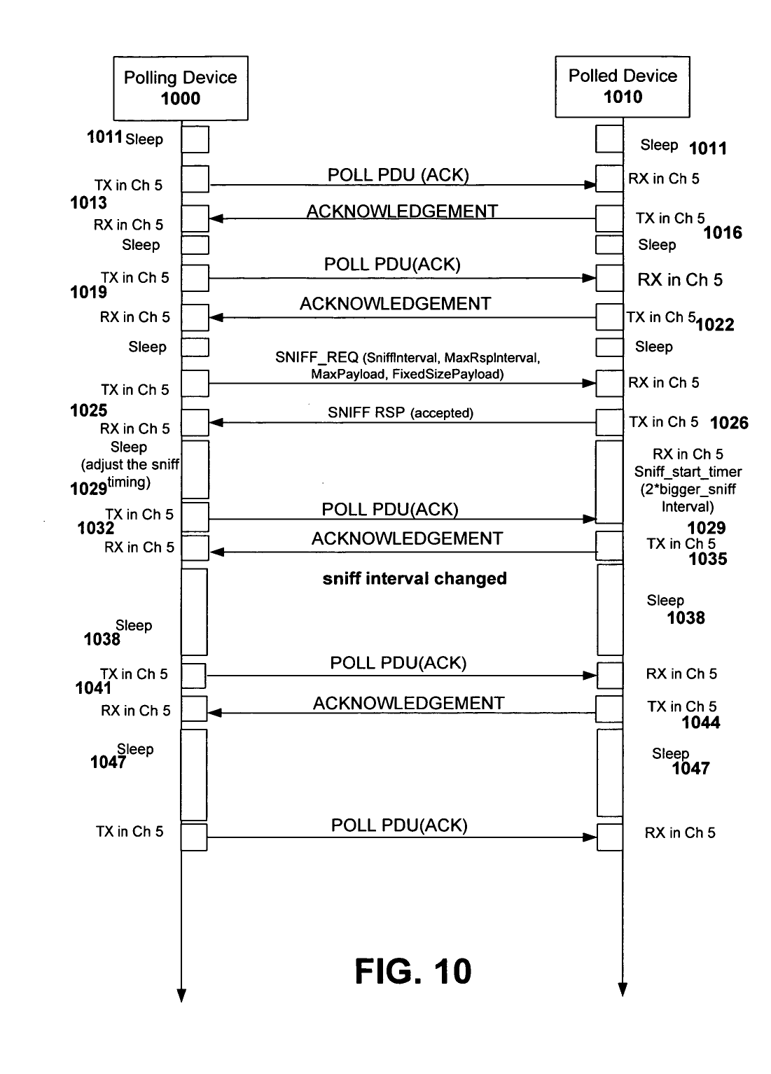

FIG. 10 illustrates the devices in a symmetrical low activity mode, when the polling device initiates a change in the sniff interval. Polling device 1000 and polled device 1010 are in a symmetrical low activity mode, implementing a sniff interval as shown with sleep state 1011. Polling Device 1000 transmits Poll PDU packets in steps (1013) and (1019), respectively. Polled device 1010 responds, in turn, by transmitting an ACKNOWLEDGEMENT in steps (1016) and (1022). In step (1025), the polling device transmits a sniff request packet including proposed new values for the SNIFFINTERVAL, MAXRSPINTERVAL, MAXPAYLOAD, and FIXEDSIZEPAYLOAD parameters. Polled device 1010, transmits a sniff response in step (1026), accepting the new parameters. The polling device 1000 and polled device 1010, use step (1029) to make the necessary adjustments to the transmission/reception timing to implement the new parameters. Accordingly, polling device transmits a Poll PDU in step (1032), and polled device 1010 responds with an ACKNOWLEDGEMENT in step (1035). Upon transmission of the ACKNOWLEDGEMENT by the polling device 1010 and receipt by the polled device 1000, the devices move into sleep state 1038 in accordance with the new sniff interval parameters. The devices continue the process of transmitting a Poll PDU, as in step (1041), transmitting a corresponding ACKNOWLEDGEMENT 1044, and entering sleep state 1047.

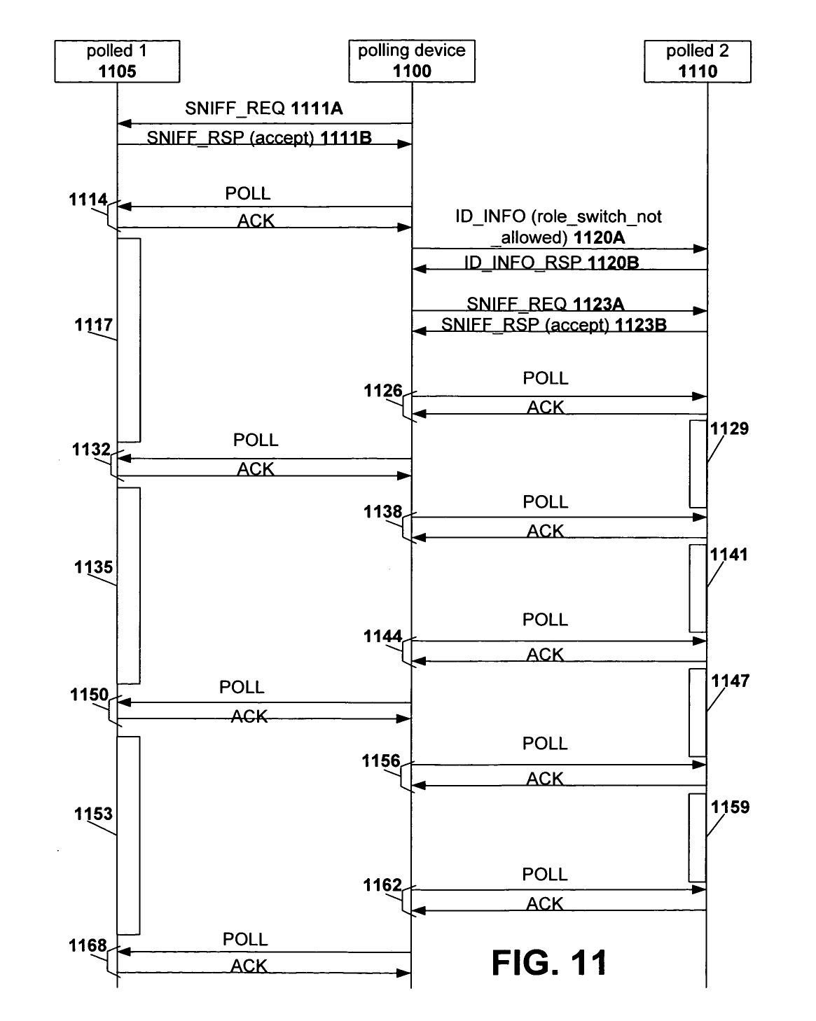

FIG. 11 illustrates an exemplary embodiment of a low activity mode in the present invention where a polling device manages communications with two polled devices. Polling device 1100 establishes and maintains a communication link with polled devices 1105 and 1110, respectively. As illustrated in FIG. 11, in order to maintain the communication links with multiple devices, the polling device establishes two distinct polling modes.

As illustrated in FIG. 11, polled device 1105 sends sniff request packet 1111A and polling device 1100 responds with sniff response 1111B accepting the sniff parameters, as discussed above. With the sniff parameters for polling device 1100 and polled device 1105 established, the devices exchange the Poll PDU and the ACKNOWLEDGEMENT in step (1114), as described above. After transmitting the ACKNOWLEDGEMENT in step (1114), polled device 1105 enters a sleep state 1117, in accordance with the parameters in the sniff request 1111A. As polled device 1105 sleeps in 1117, polling device 1100 transmits ID_INFO 1120A (with role switching disabled). Polled device 1110 receives ID_INFO 1120A and responds by transmitting ID_INFO_RSP 1120B, requesting a data transfer. The polling device transmits SNIFF_REQ 1123A to establish a low activity mode transfer. As discussed above, SNIFF_REQ 1123A includes the low activity mode timing parameters. In turn, polled device 1110 transmits SNIFF_RSP 1123B accepting the sniff parameters and prepares for the subsequent data transfer.

After the low activity mode operational (sniff) parameters are established between polling device 1100 and polled device 1110, polling device conducts Poll PDU/ACKNOWLEDGMENT exchange 1126. Upon completion of exchange 1126, polled device 1110 enters extended sleep state 1129. When polled device 1110 is in sleep state 1129, polling device 1100 conducts a Poll PDU/ACKNOWLEDGEMENT exchange 1132 with polled device 1105, after polled device 1105 exits extended sleep state 1117. Subsequently, polled device 1105 moves into sleep state 1135, after transmitting the ACKNOWLEDGEMENT, as part of exchange 1132. Polling device 1100 conducts Poll/Ack exchange 1138 with polled device 1110, after polled device exits extended sleep state 1129.

As illustrated in FIG. 11, polling device 1100 implements a sleep state with a shorter duration with polled device 1110, than with polled device 1105. Accordingly, polled device 1110 exits sleep state 1141 and participates in Poll PDU/ACKNOWLEDGEMENT exchange 1144, while polled device 1105 is still in sleep state 1135. Polling device 1100 manages and maintains multiple data transfers in subsequent Poll PDU/ACKNOWLEDGEMENT exchanges 1150, 1168 with polled device 1105, and exchanges 1156, 1162 with polled device 1110, while the non-active device is in a sleep state 1153 or 1147, 1159, respectively.

From the foregoing exemplary embodiments, it is readily appreciated that the aforementioned techniques provide flexible connectivity attributes, as well as low power consumption characteristics for both polling and polled devices. For instance, in maintaining a communication link in both low activity modes, symmetrical and asymmetrical, a faster data transfer is achieved than found in unconnected devices that must re-establish a communication link before transferring data. Devices implementing these techniques may conserve power by periodically entering a sleep state. Devices implementing the low activity mode sleep state in coordination with polling role switching, obtain higher power conservation, since power sensitive devices may delegate or assume the role of polling/polled device.

II. Efficient Polling

FIG. 11 provides an example of a terminal device communicating with two other devices. However, terminal devices may also communicate with a large number of remote devices. In certain instances, the terminal may employ different transmission modes (e.g., Bluetooth and BT LEE) for communicating with these devices.

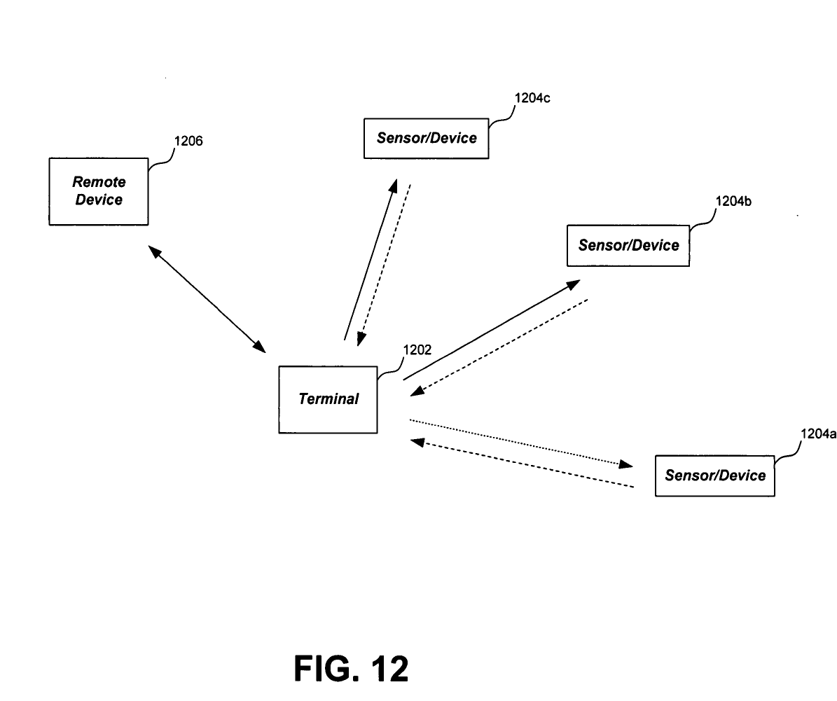

For instance, FIG. 12 is a diagram of an environment in which a terminal device 1202 engages in Bluetooth LEE connections with a plurality of sensor/devices 1204. In addition, terminal device 1202 engages in a regular Bluetooth connection with a remote device (e.g., a headset) 1206.

Communications with device 1206 may be at a higher data rate than with devices

For instance, the environment of FIG. 12 may involve fitness/health sensing applications. In one such application, sensors/devices 1204 may be motion/acceleration sensors attached to a person for detecting the person's movements. In contrast, remote device 1206 may be a Bluetooth headset for controlling terminal 1202 through voice control and for making phone calls. In a further application, sensors/devices 1204 may be electro cardiogram (ECG) measuring devices, while remote device 1206 may be a Bluetooth headset or other accessory device (e.g., a media player). It is important to note, however, that other types of applications can employ the techniques of the present invention.

In such environments, it may take a considerable amount of time (as well as power) for a terminal device to request and obtain information from several sensors/devices. As discussed above, IEEE 802.15.4 attempts to address this issue with a Guaranteed Time Slot (GTS) concept in slotted beacon intervals. However, this approach has several drawbacks. For instance, this approach does not offer dual mode or multi-mode devices (e.g., Bluetooth and Bluetooth LEE devices) with a reasonable way of defining the GTS periods so that other radio techniques can be supported or arranged.

Embodiments of the present invention provide a delay mask parameter that may be employed during a sensor/device sniff negotiation. This delay mask parameter identifies a time position (or a delay value) when a certain sensor/device is allowed to respond. This delay value can be tied to a terminal's repeatedly occurring polling time. For example, a response time for a certain sensor/device is measured in delay mask units after the moment of the poll message. Through employment of such masks, a single poll message from a terminal device can obtain responses (or input) from several sensors/devices.

Delay mask parameters are allocated so that other radio techniques may be supported by the same device. More particularly, delay mask parameters are calculated so that support or transmissions for other radio techniques (e.g. Bluetooth) can be arranged after or between sensor/device responses. Such arrangements depend on the time requirements of the other radio techniques. In aspects of the present invention, these parameter values (which provide delay spread) can also be changed dynamically. This feature may be utilized to accommodate for various changing conditions, such as drifts between radios or connection changes among radios.

In addition, aspects of the present invention provide ACK mask parameters during sensor/device sniff negotiations. These parameters allow for terminals to acknowledge responses from several sensors/devices through the transmission of a single poll message. For instance, each ACK mask parameter defines a position of an individual ACK bit in a multiple bit ACK mask. This ACK mask is included in a terminal's poll packet. Upon receipt of this packet, multiple sensors/devices will receive ACK information through their respective ACK bits. This received ACK information involves previous transmissions from sensors/devices to the terminal. Based on this received information, each sensor/device can determine how to react (i.e., retransmit or not).

As discussed above, Bluetooth LEE provides for a simple “sensor” radio that can be integrated into Bluetooth radio in a straightforward manner. Thus, a device may have multi-mode capabilities. For example, a device may possess both simple low power sensor radio (Bluetooth LEE) and higher data rate radio (e.g., regular Bluetooth) capabilities.

Described below is a multi-mode device, such as terminal device 1202 having, for example, Bluetooth and Bluetooth LEE capabilities. In the following examples, this device (referred to as a terminal) operates as a polling device in which it polls one or more remote devices (referred to as a sensor/device). This polling involves the terminal transmitting poll packets. These poll packets provide information to sensors/devices that are not actively communication communicating with the terminal.

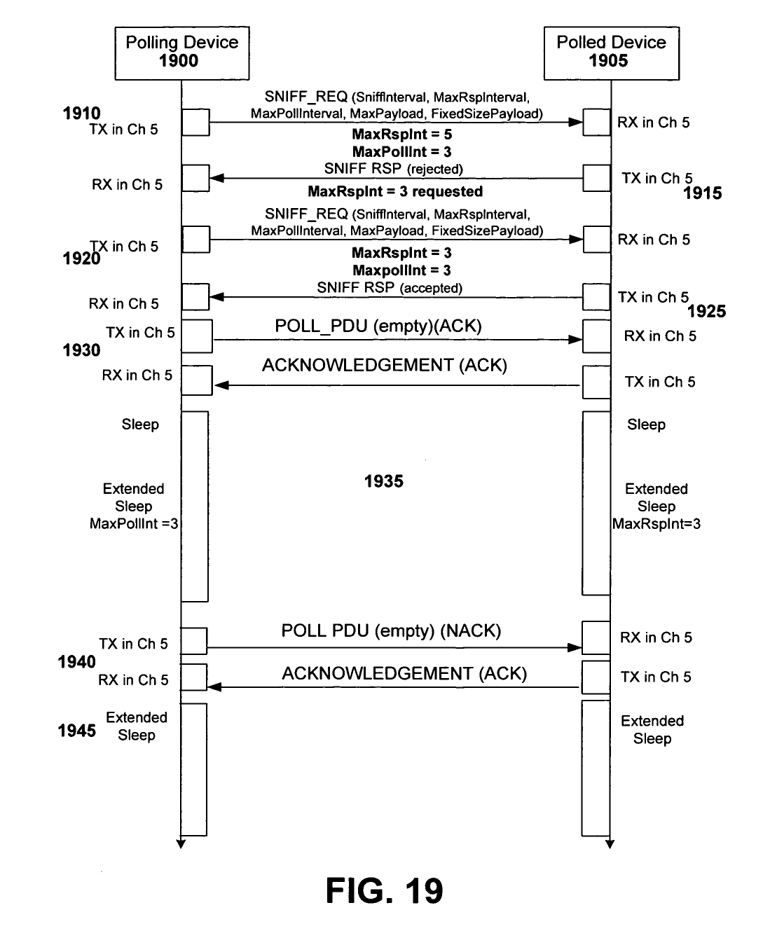

The terminal can place devices/sensors in “sniff mode”. As described above, devices/sensors operating in this mode can sleep most of the time—only waking up to listen poll packets from the terminal. Also when “sniff subrating” is employed, the devices/sensors do not need to listen to every poll packet. Sniff subrating is described in greater detail below with reference to FIG. 19.

In embodiments of the present invention, the terminal achieves optimal power efficiency by acquiring information from several sensors/devices with a single poll message. To do this, timing parameters are negotiated with each sensor/device upon its entry into the sniff mode. Table 1, below, lists exemplary timing parameters (Delay_mask and ACK_mask). In the context of Bluetooth LEE, these parameters may be incorporated into a SNIFF_REQ packet.

TABLE 1
Timing Parameters for Efficient Polling Operation

| Parameter | Description |
|---|---|
| Delay_mask | Delay_mask defines the starting position of the polled |
| | device's response. |
| ACK_mask | ACK_mask defines an ACK bit position in poll |
| | messages for a polled device. |

With the delay mask, the terminal controls when an individual sensor/device is going to respond. More particularly, the delay mask defines a position in time related to the terminal's poll packet. This defined position is when the sensor/device can send data to the terminal. In aspects of the present invention, the delay mask is defined so that other supported radio modes can operate between polls or between different sensor/device responses to poll.

By defining a maximum payload size, particular delays can be specified for multiple (e.g., consecutively polled) sensor/devices so that they can respond. Maximum payload size may be defined, for example, in the Bluetooth LEE SNIFF_REQ packet. Moreover, with the poll packet, the terminal can also send data to one or more sensors/devices.

With the ACK mask, the terminal may indicate which sensors/devices have previously responded. In embodiments, the ACK mask is a plurality of bits in which each bit corresponds to a particular sensor device. The setting of each bit indicates whether the corresponding sensor device has previously responded. Each sensor/device is informed of its particular bit through an ACK_mask parameter transmitted, for example, in a SNIFF_REQ packet.

As described above, polling packets may be directed to multiple sensors/devices. Accordingly, in embodiments, a terminal may store parameters (e.g., Delay_mask and ACK_mask parameters) for each sensor/device polled by the terminal. An indexing scheme may be employed for these parameters. For instance, an index value (referred to below as n) may be assigned for the parameters of each particular sensor device. In embodiments of the present invention, index values are sequentially assigned in the order of sensor/device polling. Thus, for a first polled sensor/device, n=0, for a second polled device n=1.

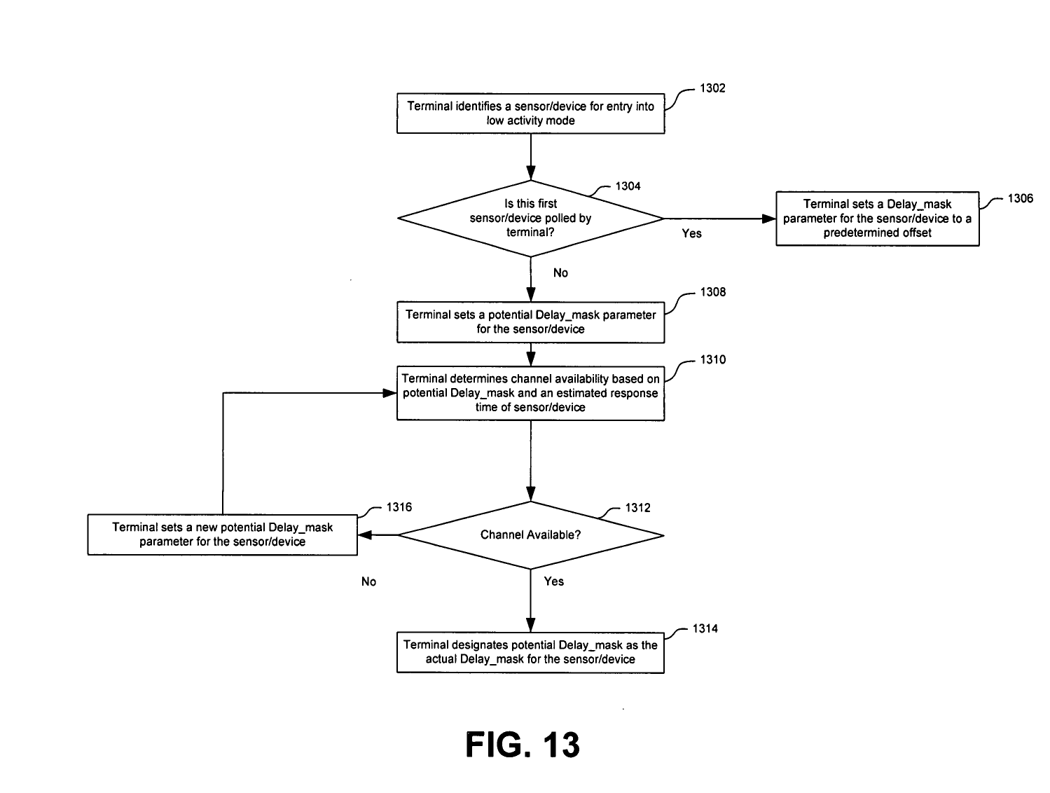

FIG. 13 is a flowchart of an operation that a terminal may employ for assigning Delay_mask parameters to one or more sensors/devices, according to embodiments of the present invention. As shown in FIG. 13, this operation includes a step 1302. In this step, the terminal identifies a sensor/device that it plans to request (or direct) to enter a low activity mode. In embodiments, this message may be a SNIFF_REQ packet.

In a step 1304, the terminal determines whether this sensor/device is the first sensor/device polled by the terminal (e.g., whether n=0). If so, then the terminal sets its Delay_mask parameter to an offset, which does not overlap with any other transmissions or receptions, in a step 1306. However, if the terminal determines that it is not the first polled sensor/device (e.g., if n>0), then a step 1308 is performed.

In step 1308, the terminal sets potential Delay_mask parameter for this sensor/device based on the previously polled device's Delay_mask parameter and an estimated response time, which includes time to send out the packet and possible guard time, of this previously polled device. As example of this is expressed below in Equation (1):
Potential_Delay_mask[n]=Delay_mask[n−1]+Est_response_time[n−1] (1)

Next, in a step 1310, the terminal determines channel availability between the times of the potential delay mask determined in step 1308 and the transmission time (e.g., estimated response time of the corresponding sensor/device. This determination is made for the purposes of multimode support. For instance, the terminal determines whether this time interval needs to be reserved (or is currently being used) for other types of transmissions, such as regular Bluetooth traffic.

As indicated by a step 1312, if the channel is available during this time interval, then operation proceeds to a step 1314. In this step, the terminal designates the potential delay mask as the intended delay mask for the sensor/device currently under consideration. However, if the channel is unavailable (e.g., busy) during this time interval, then operation proceeds to a step 1316.

In step 1316, the terminal assigns a new potential delay mask for the sensor/device under consideration. Thus, as shown in FIG. 13, operation returns to step 1310 so that the terminal may consider this new potential mask in connection with channel availability.

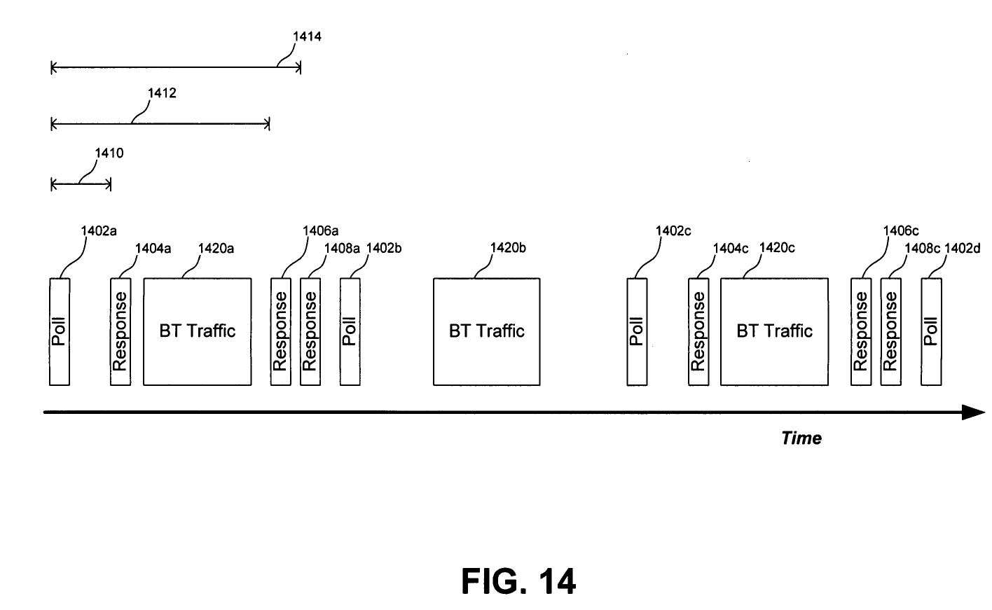

FIG. 14 is a diagram of a sequence of transmissions, according to embodiments of the present invention. In this sequence, a terminal (such as terminal 1202) periodically transmits polling packets 1402. In addition, multiple sensor/devices transmit polling packet responses. Each of these responses are delayed from their corresponding polling packets by a particular delay interval. For instance, a first sensor/device (such as sensor/device 1204a) transmits responses 1404 at a delay interval 1410. Also, a second sensor/device (such as sensor/device 1204b) transmits responses 1406 at a delay interval 1412, and a third sensor/device (such as sensor/device 1204c) transmits responses 1408 at a delay interval 1414.

Delay intervals 1410, 1412, and 1414 are based on the delay mask parameters of their corresponding sensors/devices. In embodiments, these parameters are integers. For example, the delay mask value corresponding to intervals 1410, 1412, and 1414 could be 1, 6, and 8, respectively. The actual delay intervals may be calculated according to various techniques. For instance, they may be determined from the mask values through the employment of a predetermined multiplier or coefficient.

Additionally, FIG. 14 shows periodically occurring time intervals 1420. These intervals may be used for an alternative transmission mode. For example, with reference to FIG. 12, intervals 1420 may be used for regular Bluetooth transmissions with device 1206. As described above, such transmissions may involve the transfer of higher data rate transmissions, such as voice traffic.

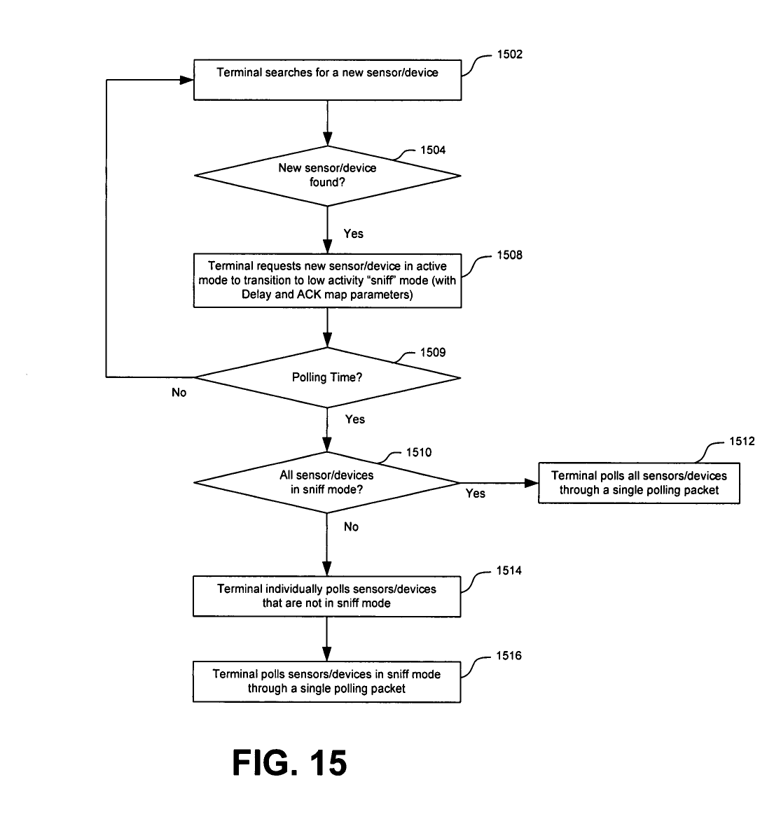

FIG. 15 is a flowchart of a terminal operation, according to embodiments of the present invention. This operation includes a step 1502, in which the terminal searches for new sensor/device. As indicated by a step 1504, if a new sensor/device is found, then the terminal makes a connection (e.g., a Bluetooth LEE active mode connection) with it in a step 1506.

In a step 1508, the terminal requests a sensor/device in active mode to go into sniff mode. This request involves Delay_mask and ACK_mask parameters. As indicated by a step 1509, steps 1510-1516 are performed when a polling time approaches. Otherwise, operation returns to step 1502

In step 1510, the terminal determines whether all of the sensors/devices to which it is connected are in sniff mode. If so, then step 1512 is performed. Otherwise, step 1514 is performed.

In step 1512, the terminal polls the sensors/devices through a single polling packet (if all of the sensors/devices are supporting single polling operation). This packet may employ an ACK_mask, as described herein. In response, the terminal may receive data from these sensors/devices.

In step 1514, the terminal individually polls the sensors/devices that are not in sniff mode, as well as any sensors/devices that are in sniff mode but do not support single polling operation. However, as shown by step 1516, the terminal may poll any sensors/devices that are in sniff mode through a single polling packet if all of such sensors/devices are supporting this.

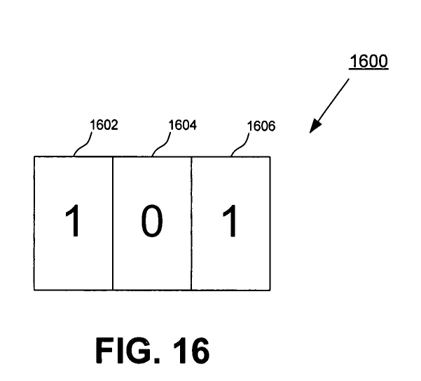

FIG. 16 illustrates an exemplary ACK_mask 1600 that a terminal (such as terminal device 1202) may employ when it is communicating with devices (such as sensor/devices 1204a-c) that are in a low activity or sniff mode. In embodiments of the present invention, ACK_mask 1600 may be included in polling messages sent by the terminal.

As shown in FIG. 16, mask 1600 includes three bits. However, any number of bits may be used. Each of these bits indicates whether a transmission has been previously received from a corresponding sensor/device. For instance, FIG. 16 shows mask 1600 having a first ACK bit 1602 corresponding to a first sensor/device, a second ACK bit 1604 corresponding to a second sensor/device, and a third ACK bit 1606 corresponding to a third sensor/device.

ACK bits 1602 and 1606 are each set to “1”. This signifies, for example, that the terminal has correctly received previous packets from the first and third sensors/devices. However, ACK bit 1604 is set to “0”. This signifies, for example, that the terminal has not received a previous packet from the second sensor/device correctly. Thus, the second sensor/device can now retransmit a previously sent packet and/or send the terminal new data if needed.

In embodiments of the present invention, the terminal may also inform sensors/devices that the polling message transmission time may be delayed. Such delays may occur for various reasons, such as the need to fulfill other radio support duties. In the context of BT LEE, this information may be included, for example, as a parameter in a SNIFF_REQ packet. With this parameter, the sensors/devices can know whether a terminal polling message will be delayed, and if so, by how much. From this knowledge, the sensors/devices can then extend their polling message search windows commensurately.

In further embodiments of the present invention, parameters may be provided that define links between particular devices as being bidirectional (i.e., 2-way). In the context of BT LEE, such parameters may be included in SNIFF_REQ and/or POLL packets. Over such bidirectional links, the terminal can send data to the corresponding sensor/device during allocated sniff time.

As described herein, poll packets may include data. Accordingly, in embodiments of the present invention, the sequence numbering for data portions of poll packets is defined individually to each sensor device. However, if broadcast is used, the sequence numbering is defined according to broadcast connection(s). For example when a terminal device is sending a poll packet to several sensors, the poll packet can include data to one sensor (“sensor 1”). In embodiments, the sequence numbering of the data part going to sensor 1 is individual. That is, if the terminal device sends data to a second sensor device (“sensor 2”) in next poll packet, then the next poll packet containing data for sensor 1 obeys the sensor numbering regarding to previous data transmission to sensor 1. However, as stated above, the sequence numbering for broadcast data is done according to broadcast connection (i.e. without individual sensor based numbering).

III. Wireless Communications Device

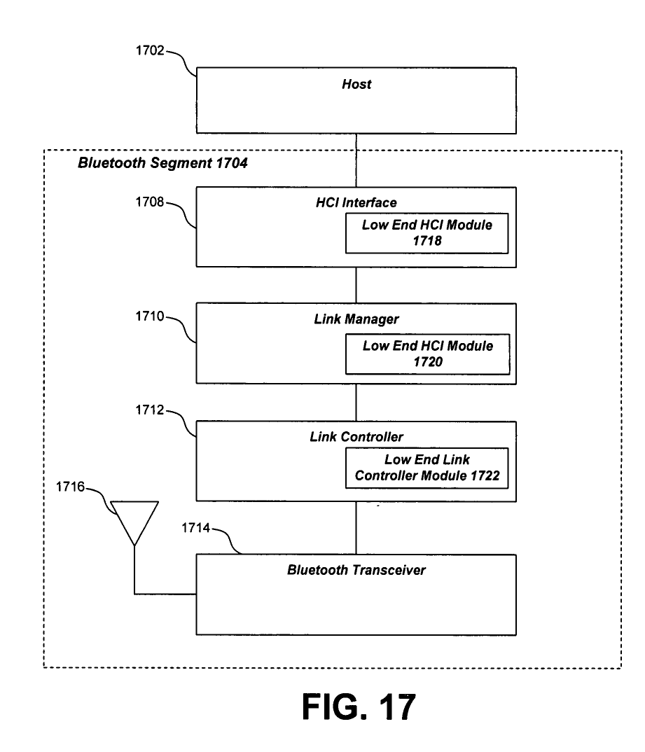

FIG. 17 is a block diagram showing a wireless communications device architecture, which may be used for devices, such as terminal device 1202. Although this architecture is described in the context of Bluetooth communications, it may be employed with other wireless communications technologies.

The device architecture of FIG. 17 includes a host 1702, which is coupled to a Bluetooth segment 1704. Host 1702 is responsible for functions involving user applications and higher protocol layers, while Bluetooth segment 1704 is responsible for lower layer protocols. More particularly, Bluetooth segment 1704 is responsible for Bluetooth specific communications with other devices (in both “standard” and low end radio communications).

As shown in FIG. 17, Bluetooth segment 1704 includes a host controller interface (HCI)1708, a link manager 1710, a link controller 1712, a Bluetooth transceiver 1714, and an antenna 1716.

Link manager 1710 performs functions related to Bluetooth link set-up, security and control. These functions involve discovering corresponding link managers at remote devices and communicating with them according to a link manager protocol (LMP). To perform these functions, LMP defines a set of messages, which are also referred to as protocol data units (PDUs). Link manager 1710 exchanges these PDUs with link managers at remote devices.

FIG. 17 shows that link manager 1710 includes a low end link manager module 1720. This module performs functions related to low end radio link set-up, security and control. For example, module 1720 may generate and process the various messages, as described herein.

Link manager 1710 (as well as low end link manager module 1720) exchanges information with host 1702 across HCI 1708. This information may include commands received from host 1702, and information transmitted to host 1702. HCI 1708 defines a set of messages, which provide for this exchange of information. As shown in FIG. 17, HCI 1708 includes a low-end HCI module 1718, which may be responsible for the exchange of information with link manager 1710 that involves low-end radio communications. For instance, low-end HCI module 1718 may provide for specific messages, which provide for this exchange of low end specific information.

Link controller 1712 operates as an intermediary between link manager 1710 and Bluetooth transceiver 1714. Link controller 1712 also performs baseband processing for Bluetooth transmission, such as error correction encoding and decoding. In addition, link controller 1712 exchanges data between corresponding link controllers at remote devices according to physical layer protocols. Such functions related to low end radio communications may be performed by a low end module link controller module 1722, which is included in link controller 1712.

FIG. 17 shows that Bluetooth transceiver 1714 is coupled to an antenna 1716. Transceiver 1714 includes electronics that allow the device of FIG. 17 (in conjunction with antenna 1716) to exchange wireless Bluetooth signals with devices, such as remote device 104. Such electronics include modulators and demodulators, amplifiers, and filters.

In embodiments of the present invention, sensors/devices may have architectures similar to the architecture of FIG. 17. However, HCI 1708, link manager 1710, and link controller 1712 may be “stripped down” to merely include their respective low end modules 1718, 1720, and 1722.

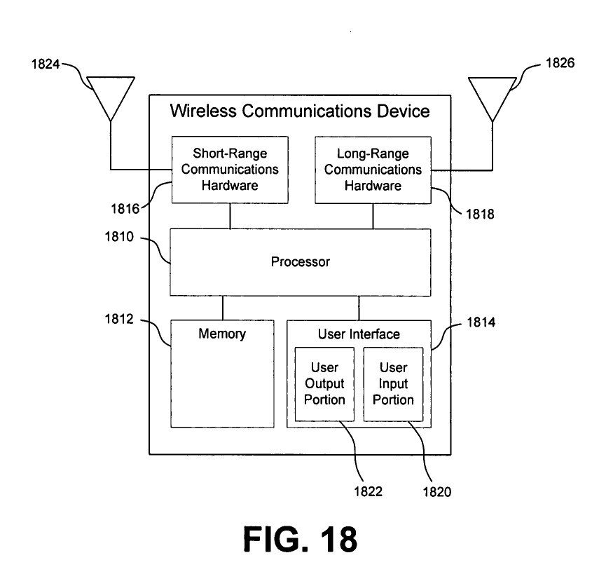

The architecture of FIG. 17 may be implemented in hardware, software, firmware, or any combination thereof. One such implementation is shown in FIG. 18. This implementation includes a processor 1810, a memory 1812, and a user interface 1814. In addition, the implementation of FIG. 18 includes transceiver 1714 and antenna 1716.

Processor 1810 controls device operation. As shown in FIG. 18, processor 1810 is coupled to transceiver 1714. Processor 1810 may be implemented with one or more microprocessors that are each capable of executing software instructions stored in memory 1812.

Memory 1812 includes random access memory (RAM), read only memory (ROM), and/or flash memory, and stores information in the form of data and software components (also referred to herein as modules). The data stored by memory 1812 may be associated with particular software components.

The software components stored by memory 1812 include instructions (computer program products) that can be executed by processor 1810. Various types of software components may be stored in memory 1812. For instance, memory 1812 may store software components that control the operation of transceiver 1714. Also, memory 1812 may store software components that provide for the functionality of processor 1810 to perform the techniques described herein.

For instance, the software components may allow processor 1810 to generate the various messages or packets described herein, and to transmit them through corresponding hardware (e.g., transceiver 1714). Also, the software components may allow processor 1810 to process received transmissions.

As shown in FIG. 18, user interface 1814 is also coupled to processor 1810. User interface 1814 facilitates the exchange of information with a user. FIG. 18 shows that user interface 1814 includes a user input portion 1820 and a user output portion 1822. User input portion 1820 may include one or more components that allow a user to input information. Examples of such components include keypads, touch screens, and microphones. User output portion 1822 allows a user to receive information from the device. Thus, user output portion 1822 may include various components, such as a display, and one or more audio speakers. Exemplary displays include liquid crystal displays (LCDs), and video displays.

As described above, transceiver 1714 provides for the transmission and reception of signals through antenna 1716. Accordingly, these portions may include components (e.g., electronics) that perform functions, such as modulation, demodulation, amplification, and filtering.

The elements shown in FIG. 18 may be coupled according to various techniques. One such technique involves coupling transceiver 1714, processor 1810, memory 1812, and user interface 1814 through one or more bus interfaces. In addition, each of these components is coupled to a power source, such as a removable and/or rechargeable battery pack (not shown).

IV. Sniff Subrating

As described above, sensors/devices do not need to listen to every poll packet when “sniff subrating” is employed. An example of sniff subrating (also referred to as an extended sleep state) is described below with reference to FIG. 19. In particular, FIG. 19 illustrates the device negotiation of the extended sleep state. Polling device 1900 transmits a SNIFF REQ at step 1910. The SNIFF REQ proposes entering an extended sleep state (low activity mode) with the low activity parameters set to MaxRsplnt=5 and the MaxPollInt=3.

MaxRspInt represents the number of polling messages that polled device 1905 (e.g., five). MaxPollInt represents the number of polling messages that polling device 1900 may selectively refrain from transmitting (e.g., three). Polling device 1900 does not necessarily have to refrain from transmitting any polling messages, but in accordance with the MaxPollInt=3, polling device 1900 cannot refrain from transmitting more than three polling messages during a given extended sleep mode.

In this example, it is assumed that the polled device 1905 wishes to maintain a quicker connection with the polling device 1900 (i.e., short sleep periods that provide faster data updates/transfers). Accordingly, the SNIFF RSP message transmitted by polled device 1905 in step 1915 indicates that the proposed SNIFF REQ is rejected. The SNIFF RSP includes a new proposed MaxRspInt=3. Polling device 1900 receives the SNIFF RSP and updates the MaxRspInt parameter with the new proposed value. Polling device 1900 thereupon transmits an updated SNIFF REQ in step 1920 that reflects the requested new value of MaxRspInt=3. Polled device 1905, recognizing an acceptable activity parameter, transmits an acceptance of the updated sniff request in step 1925.

Once the low activity parameters are established, data transfer in a low activity mode is executed. The devices transmit data in poll event 1930 and then enter extended sleep state 1935 in accordance with the negotiated low activity parameter(s). As illustrated in FIG. 19, in accordance with the accepted parameter set, polling device 1900 refrains from transmitting three polling messages and polled device 1905 ignores three polling messages. It is to be understood that the process of “ignoring” a polling message ordinarily means the polled device can refrain from tuning to the designated transmission channel to attempt to receive (listen for) a polling message. After the extended sleep period is complete, the devices execute poll event 1940 and then enter extended sleep in step 1945. It is to be understood that either polling device 1900 or polled device 1905 may reject a sniff request and propose alternate low activity parameters.

One of the advantages of such features is that it provides a more efficient way of synchronizing the transmission/response interactions of communications devices. In the example described herein, both the polling/polled devices are informed when the other device will transmit/listen for a polling message. The optimization conserves power by minimizing the transmission of polling messages when the polled device is not listening and will not respond. Similarly, the optimization conserves power by minimizing the periods of time when the polled device listens for a polling message on the transmission channel.

V. Conclusion

While various embodiments of the present invention have been described above, it should be understood that they have been presented by way of example only, and not in limitation. For instance, the present invention is not limited to Bluetooth and Bluetooth low end communications.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
(a) allocating a plurality of polling response transmission times for a corresponding plurality of remote devices, the remote devices operating according to a first wireless transmission mode, wherein the plurality of polling response transmission times are outside of a time interval designated for communications according to a second wireless transmission mode;
(b) transmitting a polling packet to the plurality of remote devices;
(c) receiving one or more responses to the polling packet, wherein each of the responses is sent by one of the remote devices during its corresponding polling response transmission time; and
(d) communicating according to the second wireless transmission mode during the time interval designated in step (a).

2. The method of claim 1, wherein each of the polling response transmission times is offset from a polling packet transmission time by a corresponding delay interval.

3. The method of claim 1, wherein step (a) comprises, for each remote device:
sending a request to the remote device to move from an active mode to a low-activity mode, the request including the polling response transmission time corresponding to the remote device.

4. The method of claim 3, wherein the low-activity mode is a Bluetooth low end radio sniff mode.

5. The method of claim 1, wherein step (b) comprises including an indication in the polling packet, the indication identifying whether transmissions from each of the remote devices have been previously received.

6. The method of claim 5, wherein the indication comprises a plurality of bits, each of the bits corresponding to a respective one of the plurality of remote devices.

7. The method of claim 6, further comprising:
sending to each of the plurality of remote devices a corresponding bit position in the plurality of bits.

8. The method of claim 7, wherein said sending step comprises sending a Bluetooth low end radio SNIFF_REQ packet.

9. The method of claim 1, wherein the first wireless transmission mode is Bluetooth low end radio and the second wireless transmission mode is Bluetooth.

10. The method of claim 1, wherein step (a) comprises, for each of the plurality of remote devices:
generating a potential response transmission time for the remote device;
determining whether the potential response transmission time is outside of a time interval designated for communications according to the second wireless transmission mode; and
when the potential response transmission time is outside of the time interval, setting the potential response transmission time as the polling response transmission time for the remote device.

11. A method, comprising:
(a) designating a device from a plurality of remote wireless communications devices, the plurality of remote wireless communications devices communicating according to a first wireless transmission mode;
(b) setting a delay parameter for the designated device, the delay parameter measured from a polling message transmission time and establishing when the designated device is authorized to respond to the polling message, said setting step comprising;
(i) generating a potential response transmission time for the designated device;
(ii) determining whether the potential response transmission time is outside of a time interval designated for communications according to the second wireless transmission mode; and
(iii) when the potential response transmission time is outside of the time interval, setting the potential response transmission time as the polling response transmission time.
(c) transmitting the delay parameter to the designated device.

12. The method of claim 11, wherein step (c) comprises transmitting the delay parameter in a message requesting the designated remote device to enter a low activity mode.

13. The method of claim 11, wherein the first wireless transmission mode is Bluetooth low end radio and the second wireless transmission mode is Bluetooth.

14. An apparatus, comprising:
means for allocating a plurality of polling response transmission times for a corresponding plurality of remote devices, the remote devices operating according to a first wireless transmission mode, wherein the plurality of polling response transmission times are outside of a time interval designated for communications according to a second wireless transmission mode;
means for transmitting a polling packet to the plurality of remote devices;
means for receiving one or more responses to the polling packet, wherein each of the responses is sent by one of the remote devices during its corresponding polling response transmission time; and
means for communicating according to the second wireless transmission mode during the designated time interval.

15. The apparatus of claim 14, wherein each of the polling response transmission times is offset from a polling packet transmission time by a corresponding delay interval.

16. The apparatus of claim 14, wherein said means for allocating a plurality of polling response transmission times comprises, for each remote device:
means for sending a request to the remote device to move from an active mode to a low-activity mode, the request including the polling response transmission time corresponding to the remote device.

17. The apparatus of claim 16, wherein the low-activity mode is a Bluetooth low end radio sniff mode.

18. The apparatus of claim 14, wherein said means for transmitting a polling packet comprises means for including an indication in the polling packet, the indication identifying whether transmissions from each of the remote devices have been previously received.

19. The apparatus of claim 14, wherein the first wireless transmission mode is Bluetooth low end radio and the second wireless transmission mode is Bluetooth.

20. A computer program product comprising a computer useable medium having computer program logic recorded thereon for enabling a processor to control a wireless communications device, the computer program logic comprising:
program code for allocating a plurality of polling response transmission times for a corresponding plurality of remote devices, the remote devices operating according to a first wireless transmission mode, wherein the plurality of polling response transmission times are outside of a time interval designated for communications according to a second wireless transmission mode;
program code for causing the wireless communications device to transmit a polling packet to the plurality of remote devices;
program code for causing the wireless communications device to receiving one or more responses to the polling packet, wherein each of the responses is sent by one of the remote devices during its corresponding polling response transmission time; and
program code for causing the wireless communications device to communicate according to the second wireless transmission mode during the designated time interval.

21. A method, comprising:
(a) receiving an allocation of a polling response transmission time from a polling device;
(b) receiving a polling packet from the from the polling device, wherein the polling packet is directed to a plurality of devices; and
(c) transmitting a response to the polling packet during the allocated polling response time.

22. The method of claim 1, wherein step (b) includes receiving an indication in the polling packet, the indication identifying whether transmissions from each of the plurality of devices have been previously received.

23. The method of claim 2, wherein the indication comprises a plurality of bits, each of the plurality of bits corresponding to a respective one of the plurality of devices.

24. An apparatus, comprising:
means for receiving an allocation of a polling response transmission time from a polling device;
means for receiving a polling packet from the from the polling device, wherein the polling packet is directed to a plurality of devices; and
means for transmitting a response to the polling packet during the allocated polling response time.
